(19) United States
(12) Patent Application Publication
(10) Pub. No.: US 2022/0148056 A1
(43) Pub. Date: May 12, 2022

(54) SYSTEM AND METHOD OF ITEM DISTRIBUTION

(71) Applicant: United States Postal Service, Washington, DC (US)

(72) Inventor: Robert E. Dixon, JR., Haymarket, VA (US)

(21) Appl. No.: 17/453,795

(22) Filed: Nov. 5, 2021

Related U.S. Application Data
(60) Provisional application No. 63/110,852, filed on Nov. 6, 2020.

(51) Int. Cl. G06Q 30/06; G06F 16/23; G06Q 30/02

(52) U.S. Cl. CPC G06Q 30/0611; G06Q 30/0222; G06F 16/23

(57) ABSTRACT

Systems and methods described herein relate to a system for handling distribution items having identifiers thereon. Item processing equipment takes and stores an image of the physical distribution item and associates the identifier with the stored image. An offer can be associated with supplemental content that can be delivered to recipients of the physical distribution item and to other recipients who did not receive the physical distribution item.

Any and all applications for which a foreign or domestic priority claim is identified in the Application Data Sheet as filed with the present application are hereby incorporated by reference under 37 CFR 1.57. This application claims the benefit of priority to U.S. Provisional Application No. 63/110,852, filed Nov. 6, 2020, the entire contents of which are hereby incorporated by reference.

### BACKGROUND

Recent advancements in the field of digital communications have resulted in a wide variety of distribution and communications paths by which a user can receive information. Because of the increased importance of electronic communications, it is desirable to enhance physical item distribution by providing novel digital features to the physical distribution item experience.

### SUMMARY

In one aspect described herein, a system for handling distribution items, comprises item processing equipment comprising an imaging device, the imaging device configured to generate an image of a physical distribution item and interpret an identifier on the physical distribution item, and to generate scan information which includes the identifier; an item image server configured to store the image of the physical distribution item and to associate the identifier with the stored image; a user interface configured to make available for viewing by a user an offer associated with the physical distribution item; and a central hub in communication with the item image server and the user interface, the central hub configured to: identify the offer associated with the physical distribution item; provide to the user a prompt whether to view the offer; receive a response to the prompt from the user; when the user views the offer: provide, to the user, the offer for viewing via the user interface; and update in a user database a user record associated with the user to indicate that the user opts to view the offer.

In some embodiments, the item identifier includes an address, a name, a brand, a symbol, or a trademark.

In some embodiments, the central hub is further configured to identify the offer associated with the physical distribution item by comparing the item identifier to a business database storing available offers in a vicinity of a recipient of the physical distribution item.

In some embodiments, the user interface is further configured to receive from the user preferences and wherein the central hub is further configured to provide the prompt to the user only if the offer is associated with the received preferences.

In some embodiments, the central hub is further configured to determine when the offer is available to be shared with the user.

In some embodiments, the offer associated with the physical distribution item comprises a digital coupon, an option for a physical sample, or an option for an in-person appointment with the corresponding business.

In some embodiments, the user record may be a user profile that the user has established by providing to the user interface personal information such as age, gender, item preferences, or recent purchases.

In some embodiments, when the user views the offer, and the user record associated with the user is updated to indicate that the user opts to view the offer, the central hub updates the user record to include the preferences associated with the offer or the physical distribution item.

In some embodiments, the user and the recipient of the physical distribution item are different entities.

In some embodiments, the user can communicate with the central hub to send the offer to a second user and have the central hub send the offer to a specific second user of the first user's choice.

In another aspect described herein, a method for handling distribution items, the method comprises: processing by item processing equipment an item by generating an image of a physical distribution item, interpreting an identifier on the physical distribution item, and generating scan information which includes the identifier; storing in a memory in communication with the image of the physical distribution item and associating the identifier with the stored image; making available via a server for viewing by the user an offer associated with the physical distribution item; identifying the offer associated with the physical distribution item available to be shared with the user; providing the user in the user interface a prompt whether to view the offer; receiving in the user interface a response to the first prompt form the user; when the user opts to view the offer: providing, to the user, the offer for viewing; and updating a user record associated with the user in a user database to indicate that the user viewed the offer.

In some embodiments, interpreting an identifier further comprises identifying item information such as an address, a name, a brand, a symbol, or trademark.

In some embodiments, identifying the offer associated with the physical distribution item availed to be shared with the user further comprises identifying the offer associated with the physical distribution item and comparing the item identifier to a business database storing available offers in a vicinity of a recipient of the physical distribution item.

In some embodiments, providing the user in the user interface a first prompt further comprises providing the prompt to the user only if the offer is associated with the received preferences.

In some embodiments, making available an offer associated with the physical distribution item comprises making an offer available such as a digital coupon, an option for a physical sample, or an option for an in-person appointment with the corresponding business.

In some embodiments, updating a user record further includes updating the user interface personal information such as age, gender, item preferences, or recent purchases.

In some embodiments, updating a user record associated with the user in a user database to indicate that the user viewed the offer further comprises including in the user record the preferences associated with the offer or the physical distribution item.

In some embodiments, the user and the recipient of the physical distribution item are different entities.

In some embodiments, providing, to the user, the offer for viewing further comprises the user providing whether the user wants to send the offer to a second user of their choice.

In another aspect described herein a system for handling distribution items, comprises item processing equipment comprising an imaging device, the imaging device configured to identify a physical distribution item, to interpret an identifier on the physical distribution item, and to generate scan information which includes the identifier; an item offer server configured to store an offer associated with the physical distribution item; a user interface configured to present the stored offer to a user of the physical distribution item and receive user inputs relating to the stored offer; and a central hub in communication with the item image server and the user interface, the central hub configured to: identify an offer, associated with the physical distribution item, available to be shared with other users; provide to the user a first prompt whether to share the offer with one or more other users; receive a response to the first prompt from the user; when the user opts to share the offer, provide, to the user, a second prompt whether to share user information along with the shared offer; receive a response to the second prompt from the user; when the user opts not to share user information along with the shared offer, provide the shared offer to the one or more other users without the user information; update a database to indicate that the user shared the offer without sharing the recipient information; and distribute the shared offer to the one or more other users for viewing by the one or more other users.

### BRIEF DESCRIPTION OF THE DRAWINGS

Enabling digital communication to recipients of distribution items, such as mail items , as well as other objects, may be achieved by systems and methods for creating, managing, and distributing content, in addition to distributing physical mail items, according to embodiments of the disclosure as described herein.

Reference will now be made to the accompanying drawings showing example embodiments of this disclosure in the drawings.

FIG. 1 depicts a diagram of various inputs available for generating a customer preference database.

FIG. 2 depicts a block diagram of an example system for managing supplemental content.

FIG. 3 is a flowchart of an exemplary method of viewing offers associated with items received by a neighbor recipient.

FIG. 4A is a flowchart of an exemplary method of viewing items and sharing offers associated with items.

FIG. 4B is a flowchart depicting an exemplary method of processing items and supplemental content.

FIG. 5A shows an example screenshot of a user interface that a user will use to view or interact with available offers

FIG. 5B shows example screenshot of a user interface that a user will use to view or interact with available offers.

### DETAILED DESCRIPTION

In the following detailed description, reference is made to the accompanying drawings, which form a part thereof. In the drawings, similar symbols typically identify similar components, unless context dictates otherwise. Thus, in some embodiments, part numbers may be used for similar components in multiple figures, or part numbers may vary depending from figure to figure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

The present disclosure relates to systems and methods for real-time creation, management, interaction, and distribution of supplemental content associated with items in a distribution network such as the United States Postal Service (USPS). This may include providing real-time sharing and/or tracking capabilities of each piece of enhanced digital content that may be associated with an item in the distribution network. The distribution network, such as the USPS, or other carriers, or other shipping or item delivery service, a warehouse, logistics company, item sorting systems, etc., may transport the items to a plurality of delivery points or destinations from a plurality of originations. The USPS will be used in the present disclosure to describe some exemplary embodiments, but the present disclosure is not limited thereto. When referencing generically to any of the services listed above or any item distribution service in addition to those listed above, the phrase “item distribution service,” “delivery service,” or “distribution system” will be used to indicate such generalities.

In order to provide the capabilities described herein, the enhanced digital content associated with the item in the distribution network and tracking data, including real-time tracking data, can be stored. In the distribution network with many items, the storage capability must be large and capable of processing large numbers of records to receive, store, and provide access to the stored digital content and tracking data. In some embodiments, the system includes a central data storage repository in communication with a powerful analytical engine with real-time processing capabilities.

A distribution network may comprise multiple levels. For example, a distribution network may comprise regional distribution facilities, hubs, and unit delivery facilities, or any other desired level. A nationwide distribution network, for example, may comprise one or more regional distribution facilities having a defined coverage area (such as a geographic area), designated to receive items from intake facilities within the defined coverage area, or from other regional distribution facilities. The regional distribution facility can sort items for delivery to another regional distribution facility, or to a hub level facility within the regional distributional facility's coverage area. A regional distribution facility can have one or more hub level facilities within its defined coverage area. A hub level facility can be affiliated with a few or many unit delivery facilities, and can sort and deliver items to the unit delivery facilities with which it is associated. In the case of the USPS, the unit delivery facility may be associated with a ZIP Code. The unit delivery facility receives items from local senders, and from hub level facilities or regional distribution facilities. The unit delivery facility also sorts and stages the items intended for delivery to destinations within the unit delivery facility's coverage area.

As used herein, the term “item” may refer to an individual article, mailpiece, object, agglomeration of articles, or container having more than one article within, in a distribution system. The item may be a letter, magazine, flat, luggage, package, box, or any other item of inventory which is transported or delivered in a distribution system or network. The term “item” may also refer to a unit or object which is configured to hold one or more individual items, such as a container which holds multiple letters, magazines, boxes, etc. The term “item” may also include any object, container, storage area, rack, tray, truck, train car, airplane, or other similar device into which items or articles may be inserted and subsequently transported, as are commonly used in distribution systems and networks.

The term “item recipient” is used in relation to describing embodiments of the present development. This term is exemplary only, and the scope of the present disclosure is not limited to the potential recipient of an item. The item recipient may be a customer as described herein.

The term supplemental content and others terms are used to describe embodiments of the present development. As used herein, supplemental content can refer to digital coupons, graphics, images, videos, emails, webpages, hyperlinks, text messages, instant messages, social media messages, text, augmented reality interfaces, and the like. These terms are exemplary only, and the scope of the present disclosure is not limited thereto.

In some embodiments, the item recipient receives items delivered by, via, and/or from the distribution network. The distribution network can be, for example, the USPS. The item recipient may select or provide delivery preferences to the distribution network, which include preferences for types of items that the item recipient would like to would or prefer to receive, personal interests, and the like. These preferences can be stored in a customer profile for each customer. Thus, the profile can store the delivery preferences for the customer, categories of interests, permissions for gathering information and data, and the like. In some embodiments, the item recipient can opt-in to a system for gathering preference information based on items delivered to the item recipient. In some embodiments, the distribution network can gather information regarding items received at a residence or by a resident through its distribution network without user input, when a user opts in to the system. The distribution network may also identify that a residence or more than one residence within a geographic area requests or receives specific periodicals, advertisements, deliveries, or other items related to a particular interest group, preference, item category, a specific sender or shipper, and the like. Additionally, since most items likely identify a resident to which they are destined or intended for delivery, the distribution network may correlate the residence receiving a specific item with the resident that is identified as being the recipient of the item, when possible. Thus, the distribution network may generate associations between residents and the residences to which the USPS delivers said items and the items and interests associated with the items. The distribution network wishes to protect the personal information of individuals and other entities to which the distribution network delivers items. Thus, the distribution may not wish to simply provide personally identifiable information (PII) to shippers or other entities. To protect the PII of customers, or of any distribution system entity, delivery point information can be anonymized and/or encrypted, as will be described below. In some embodiments, the anonymized and/or encrypted delivery point information can be stored in the customer profile, where only the USPS, or the distribution network systems, can access and read the anonymized and/or encrypted delivery point information. The anonymized and/or encrypted delivery point information can be associated in the customer profile with the actual delivery point, such as the address, of the customer.

When a shipper, retainer, sender, etc. wishes to send an item, such as a mailpiece having an offer, deal, or discount associated therewith, the shipper can select one or more categories and/or subcategories from a hierarchy of preferences provided by a user interface. The distribution network, using the shipper request, can identify delivery points of customers who have selected preferences or categories similar to or the same as those provided by the shipper. The distribution network can produce the anonymous and/or encrypted delivery point information and provide those to the shipper, as described herein.

In some embodiments, a recipient's participation in the encrypted and/or anonymized) program may utilize recipient opt-ins or may otherwise obtain permission from recipients for collection and use of information regarding mailing and receiving preferences. For example, the interest of the recipient may be gathered and analyzed by the distribution system without specific input from the recipient. Some examples of information collected to determine interests of the recipient may include item or package information, such as images of items received, characteristics of the items or packages received, such as size, weight, shape, text and/or images included thereon, etc., and sender or recipient information of items sent or received by the recipient. The distribution network can also use an opt-in preference collection system, such as via a user interface on a computing device, where recipients can provide personal or specific preferences about which types of distribution items the recipients would like to receive and from which senders recipients would like to receive items. The opt-in system can also allow recipients to identify which types of items recipients would not like to receive, and from which senders recipients would not like to receive items. These preferences can be anonymized, aggregated, or otherwise combined within the distribution network and used with senders, vendors, or other entities who desire to send items to a targeted customer base or to customers who have selected preferences which align with or are related to the business of the sender, vendor, etc.

In some embodiments, the customer can also set up a customer profile. To set up a profile, the user can fill out or complete a profile by identifying interests, retailers, senders, types of products, etc., with which they would like to be associated or affiliated. The customer may also indicate specific stores that the customer wishes to receive informed offers from. The customer may also input certain geographical ranges within which the customer wishes to receive informed offers.

In some embodiments, the customer can select from a supplied list of preferences or categories, such as sports, cars, fashion, carpentry, hobbies, outdoors, etc., or any other high level category. The customer can select subcategories within each category, such as golf, sports cars, fishing, etc. Further narrower or specific subcategories can be supplied to the subcateogries in a hierarchical format. The customer can also apply or provide customized categories or preferences, which the distribution network can analyze and incorporate into the preferences hierarchy. The preferences hierarchy can also be provided to a sender, shipper, vendor, or entity that desires to send an item or items to a customers with specific preferences.

Additionally, the household database may be used to store information regarding how many items, such as packages and similar articles, were sent or received by an address or entity and associated dates for said sending and receiving. For example, an address may receive four items in a span of three days, two of the items being packages and two of the items being letter size. The system or method may identify the letter size items as being cards based on identifying a card manufacturer logo on the envelope or based on the size of the letter size item. The packages may be identified by the system or method as being a gift based on wrapping paper or other physical markings on the packages.

The term “advertising campaign” and others terms are used when describing embodiments of the present development. As used herein, an advertising campaign can refer to an association of one or more items or pieces of supplemental content with a recipient list, a budget, and a campaign duration. These terms are exemplary only, and the scope of the present disclosure is not limited thereto.

As an example illustrating enhanced digital content provided with items, a health food store manager may want to advertise that their health food store is having a sale on organic produce. In addition to sending out direct advertisement mailers (i.e., items), the health food advertiser can enhance the physical item with content provided and delivered via the supplemental content system. The health food store begins by creating an advertising campaign using an interface associated with the supplemental content system. The advertising campaign associates a digital advertisement, provided by the health food advertiser, with mail items scheduled to be delivered to recipients via USPS. The mail item can be generated by or on behalf of the health food store. Once an item is inducted into the stream, or is scanned at the local delivery unit for delivery, or at another point during the item's transit through the mail distribution network, the item's recipient will receive an email containing detailed item data such as shipping date, scheduled delivery date, dimensions, sender identification, and an image of the item, which may be provided electronically to the item's recipient along with corresponding data for other items scheduled for delivery to that recipient for a given time period, such as a day, two days, three days, a week, and the like. The images are generally obtained from or using the mail processing equipment. Systems for providing digital information regarding the items can be similar to those described in U.S. patent application Ser. No. 13/619,074, filed on Sep. 14, 2012, now U.S. Pat. No. 9,105,016, which is incorporated herein by reference in its entirety. To illustrate, the images of the item sent by or on behalf of the health food store can include additional information embedded within or linked to the image of the mail item. In this example, the supplemental content is an image displaying an advertisement, an offer, an offer code, a promotion, an identifier, or other digital component and/or a hyperlink to an offer or coupon page on the health food store's website or other location on a network. The supplemental content can trigger a system automatically to route the same or a similar type of item to a recipient by instructing item processing equipment to process the same or similar type of item and route the item to a destination for delivery to a delivery location, such as a delivery address.

In some embodiments, the customer may also ask for samples of certain products to be sent to the customer's delivery address. For example, in response to a user interacting with the supplemental content, the local health store may sent a sample of daily multivitamins for the recipient to try before ordering. In some embodiments, the sample of the daily multivitamin may be stored at a distribution network facility, and the interaction with the supplemental content may cause an item processing system to automatically induct the sample into the distribution network and may automatically route the item in the item processing equipment for delivery to the deliver address.

In some embodiments, the supplemental content system may give the recipient an option to opt in to receive special offers and/or deals from one or more entities, for example the health food store. In some embodiments, such a system may allow the recipient to receive informed offers by opting in to receive offers based on the recipient's interests without sharing any personal information with the one or more entities providing the mail items or offers. Such a system allows the one or more entities to have potential access to additional recipients that express interest in products or services from the one or more entities while protecting the privacy of the recipients. Such informed offers may increase value of mail items by providing an additional avenue or impression (for example, the digital version) for any marketing campaign. It also provides recipients with a new way to interact with their mail and helps entities target recipients with specific interests, thereby increasing a likelihood of gaining a transaction.

In some embodiments, the supplemental content system may also track changes in addresses for a particular recipient and change their preferences in the system to the new delivery address. An individual will then have their previous preferences saved into their profile and linked to their new address so as to have informed items sent to the recipient based on their previous preferences.

An individual, business, or other entity may not be on a mailing list for a particular business, company, etc., or may not have ordered an item from a particular merchant, which merchant sent supplemental content along with physical mail in a digital format. An individual or business may, however, desire to see and use offers provided to others similar to the individual, located in a similar geographic area, meeting the same criteria in a preference profile as described elsewhere herein, or other similarities.

System and methods of the current disclosure can provide an entity with access to the digital offers or supplemental content sent to neighbors, friends, or other entities based on some criteria or preferences, including those in the entity's profile. As one example, a first entity can receive physical items from a health food store, and the first entity accesses digital content, including offers and the like, that are associated with that content, as described above. A second entity may establish a preference or request to receive offers that are sent to neighbors. The preference can be to receive offers sent to people that live on the same street, in the same neighborhood, the same ZIP code, etc., and can be further limited by category, subcategory, preference type, and the like. When the first entity receives the digital or supplemental content from the health food store, the second entity can be provided with a notification and/or an option to access the supplemental content sent to the first entity, or which was accessed by the first entity in the first entity's dashboard, email, etc., due to the second entity's preference to receive such offers. Thus, the second entity can see the health food store offer and can be able to take advantage of the offer, although the second entity did not have the physical item sent to its delivery point.

In some instances, the first entity may be provided with an option to share the received supplemental content with the second entity or other entities in the same or different geographic regions or areas. For example, the first entity can identify particular second entities, for example from a list of contacts that the first entity knows and has locally available. In some instances, the first entity can identify the second entities with which the supplemental content is shared from online contact information or by selecting one or more second entities that have opted in to receiving supplemental content. For example, the first entity may have such an option to identify one or more second entities via the first entity's dashboard.

In some embodiments the recipient may wish to link profiles with another recipient in the same or similar geographic area, in the same household, with a family member or friend, and the like. Based on a customer's profile, links, etc., the supplemental content system may send informed items or supplemental content to the customer recipient based on items sent to the first recipient. The customer may also block certain information or advertisements from being linked to another recipient's profile.

In some embodiments, important dates may be inputted by the customer into the customer's profile, so the supplement content system sends informed content based on those dates. The information from customer may include birthdays, anniversaries, important holidays celebrated in the household, etc. The supplement content system may send informed items based on the date's categorization by the recipient. The supplemental content system may also send reminders a certain number of days leading up to the date the recipient has inputted with informed items that the supplemental content system has analyzed the recipient may find useful. For example, if the type of date that is approaching is an anniversary, the supplemental content system may send a coupon to a local florist that the recipient may wish to buy flowers for the date approaching.

Further details of such an informed offers system providing the capabilities introduced above are provided below.

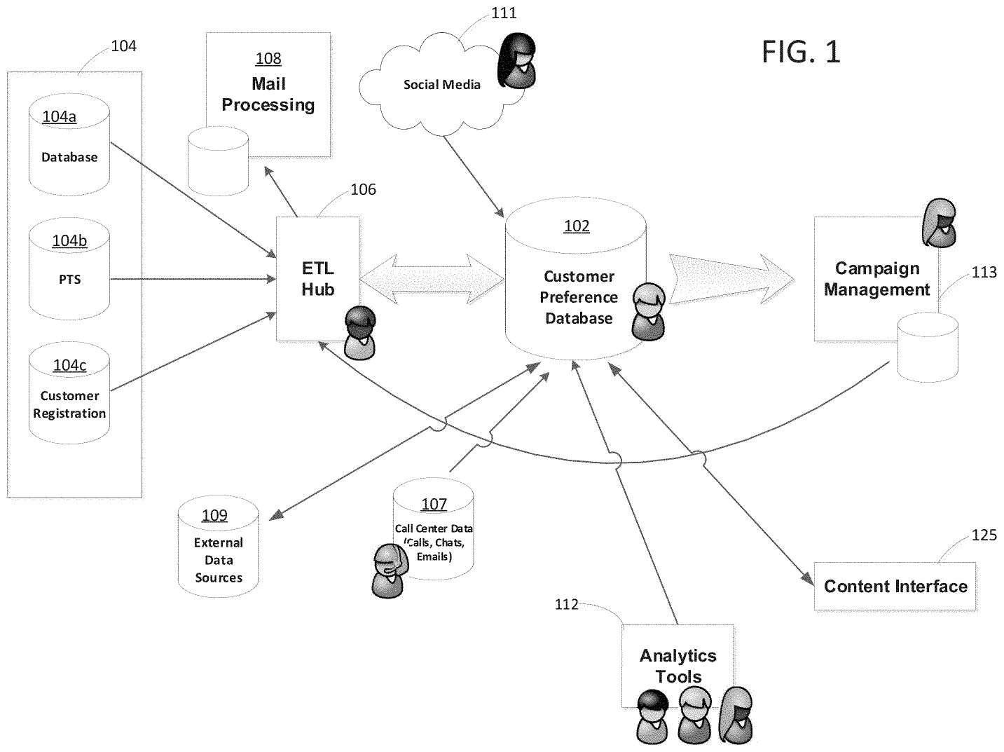

FIG. 1 depicts inputs into a customer preference database (CPDB) 102, which can be used in systems and methods described herein. The CPDB 102 can gather and store information regarding preferences and preference information for users, senders, shippers, recipients, and customers of a distribution network. The CPDB 102 can gather this information passively from other information sources, can gather preference information based on an opt-in system, or can proactively request and obtain preference information from customers, and, advantageously, recipients of mail items. The CPDB 102 can also gather this information actively from the recipients, for example for those who opt in to receive offers based on recipient identified interests.

A user can have a profile stored on the CPDB 102 which can be accessed, edited, options selected, preferences established, and the like, by the user. The profile can also be updated by the system, as described herein. For example, a user can set preferences on which types of material the user would like to receive, and can set parameters for which offers the user sees. For example, the user can identify a geographic area, can identify friends and/or neighbors, can identify particular characteristics, merchants, etc., from which the user would like to see offers which were sent to others. The profile can be edited and/or accessed by the user via, for example, an interface, the customer registration database 104c, and the like.

The information or records in the CPDB 102 can be based on core records such as information from customer database 104. The customer database 104 can be obtained from several sources within the distribution network, such as the USPS. The customer database 104 can include a recipient database 104a, a product tracking system (PTS) 104b, and a customer registration database 104c. The recipient database 104a can be a stored list of all the recipients and addresses of recipients of items delivered by the distribution network. For example, this can be a list of names and addresses of people and businesses to which the USPS delivers.

PTS 104b includes product tracking information, including the types and frequency of items, such as packages, parcels, flats, magazines, and other items which are delivered to recipients in distribution network. PTS 104b can store information about which recipients receive which types of items and the frequency thereof.

The customer registration database 104c includes information, including preferences, subscriptions, payments, etc. for all customers, such as recipients, users, etc., that have been provided to the distribution network across various platforms, such as via a mobile application, via a website, via a change of address request, or any other interaction with the distribution network where a recipient provided information. This information can be stored in the customer registration database 104c on an opt-in or opt-out basis. In some embodiments, the customer registration database 104c includes details for each customer regarding whether or not the customer opts in to receive digital offers and/or notifications of items to be delivered. In some embodiments, the recipient may use the customer registration database 104c to update recipient interests and opt-ins.

The information from the customer database 104 can be aggregated and combined in a ETL hub 106. The ETL hub 106 can take the various records from the customer database 104 and aggregate the information for storage using expand, transform, load database techniques, or any other desired techniques. The ELT hub 106 can be guided by sets of aggregation rules which direct how the customer database 104 should be aggregated. The aggregation rules may vary based on the intended application, or campaign. The ETL hub 106 provides the aggregated customer data to the CPDB 102 for storage. The ETL hub 106 can provide different sets of aggregated data for use in different applications or campaigns.

The ETL hub 106 can interface with mail processing equipment 108 to provide delivery instructions, processing and sorting instructions, routing instructions and the like. The ETL hub 106 may receive the processing instructions from the CPDB 102. The mail processing equipment 108 can include item sorting equipment, delivery vehicles, mobile delivery devices, and/or other components of the distribution network. The mail processing equipment 108 can be automated.

The CPDB 102 core records obtained from the customer database 104 may be supplemented with data from external data sources 109, customer service data 107, social media 111, and/or a recipient user interface 115. External data sources 109 may be obtained from a third-party and may be used for one or more campaigns. In some embodiments, customer or user data from the external data sources 109 may expire and may be removed after use. Customer service data 107 may be obtained from customers who interact with the distribution network, such as via a call center, online help, in-person transactions at distribution facility, such as a post office or retail location, and the like. Social media information 111 can be obtained from various social media sources and can supplement the records in the CPDB 102. The social media information 111 can include social media comments regarding product preferences, feelings about products and services, and the like.

An analytics tools engine 112 can access the customer data and profiles in the CPDB 102 and evaluate the data and profiles to determine potential new product offerings for the distribution network and customers of the distribution network. The analytics tools engine 112 can also analyze the customer profiles in the CPDB 102 to determine target recipients for particular campaigns or supplemental content, as will be described in greater detail below. The analytics tool engine 112 also analyzes historical campaign effectiveness data, can use the historical data to shape future campaigns, and/or can provide the data to an advertiser, shipper, and the like.

The CPDB 102 is in communication with a content interface 125. The content interface 125 can be provided as webtools for a shipper to query a batch of barcodes for sending a physical mail piece to a group of recipients for a particular physical distribution item. The content interface 125 can query the CPDB 102 for recipients for a particular item or campaign. The CPDB 102 can use the requirements from the content interface 125 and, using the analytics tool engine 112, can prepare a list of recipients or potential recipients for the sender or advertiser. The CPDB 102 may not provide the names and addresses of the identified recipients, but may provide a batch of barcodes, anonymized and/or encrypted, which the shipper or advertiser can place on the physical distribution items. The barcodes will be associated with the delivery points of the identified recipients, and the barcodes can be recognized by the mail processing equipment 108. More details regarding the content interface 125 will be provided elsewhere herein.

A campaign management module 113 extracts data from the CPDB 102 for execution of specific campaigns, and for determining to which entities the campaign information should be sent including those receiving a physical distribution item, and those who wish to see the campaign information where they did not receive a physical distribution item but which meet particular criteria. Response data is received from various components of the distribution network (as will be described in greater detail below) during campaign execution. The response data from the campaigns, including, for example, what interactions have occurred between items, supplemental content, etc. and recipients in the past. The response data can be received and stored in the CPDB 102. Customer profiles for customers who interact with supplemental content and/or make purchases for a campaign can be updated with the interaction and purchase data.

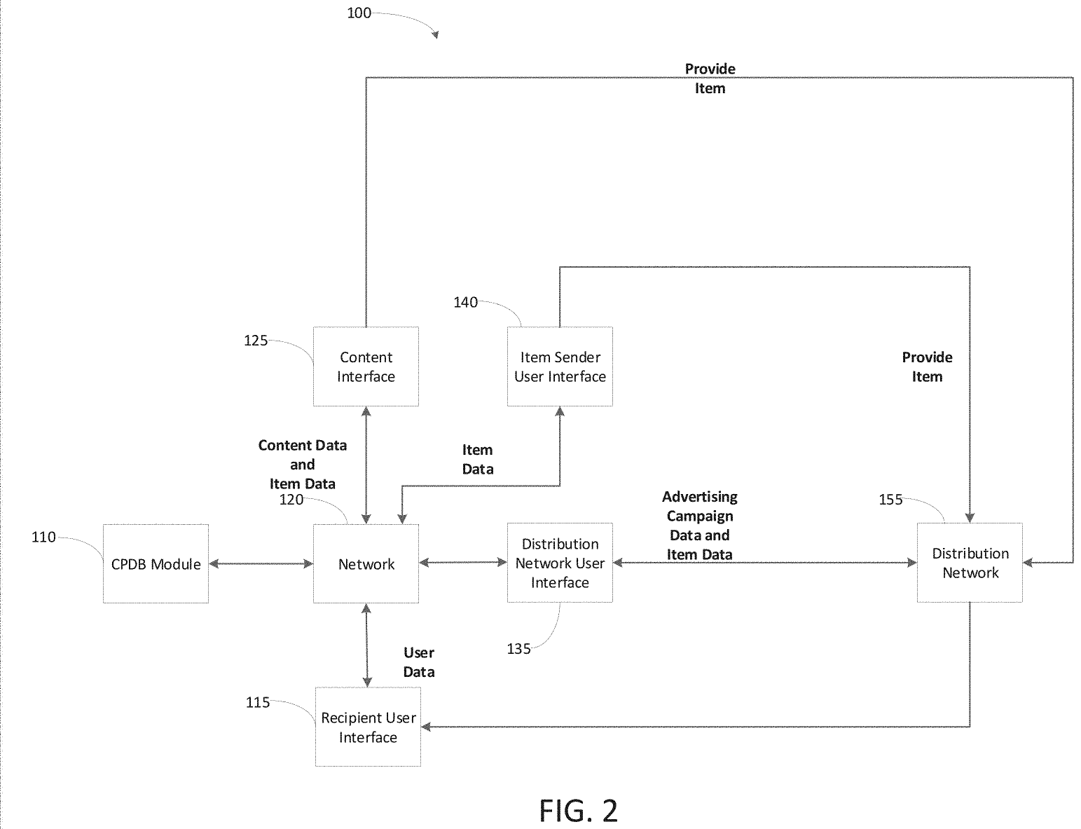

FIG. 2 depicts one embodiment of a system 100 for creation and routing of enhanced digital content. A system 100 comprises the customer service database or a customer preference database (CPDB) module 110, a distribution network 155, and the content interface 125. In some embodiments, the system 100 may additionally comprise an item sender user interface 140, a distribution network user interface 135, and a recipient user interface 115. The CPDB module 110 can be a central hub for the system 100, and is in communication, either wired or wirelessly, with the item sender user interface 140, the distribution network user interface 135, the content interface 125, and the recipient user interface 115. The various components of the system 100 can be in wired or wireless communication with each other via, for example, a network 120. In some embodiments, the interfaces described herein may be a graphical user interface, a web-based application, a mobile application, a computer, a processor, a combination of the two, or other similar device in communication with the CPDB module 110. In some embodiments, the item sender user interface 140, the distribution network user interface 135, the content interface 125, and the recipient user interface 115 may be in communication either wired or wirelessly, with the distribution network 155.

The CPDB module 110 may comprise or be a component of a processing system implemented with one or more processors. The CPDB module 110 may be a network of interconnected processors housed in one or more terminals. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The CPDB module 110 may comprise a processor such as, for example, a microprocessor, such as a modern computer processor or set of processors, e.g., dual-core, quad-core, etc.,, a microcontroller, or the like. The processor typically has conventional address lines, conventional data lines, and one or more conventional control lines. The CPDB module 110 is in communication with a memory, which may include, for example, RAM memory, flash memory, ROM memory, EPROM memory, EEPROM memory, registers, hard disk, a removable disk, a CD-ROM, or any other form of storage medium known in the art. The memory may include, for example, software, at least one software module, instructions, steps of an algorithm, or any other information. In some embodiments, the processor performs processes in accordance with instruction stored in the memory. These processes may include, for example, controlling features and/or components of the system 100, and controlling access to and from the CPDB module 110, and transmitting information and data to and from the CPDB module 110 and the constituent components of the system 100, as will be described herein. The CPDB module 110 is configured to coordinate and direct the activities of the other components of the system 100.

The CPDB module 110 is in communication, either wired or wireless, with components of the distribution network 155. The CPDB module 110 communicates item data, advertising campaign data, item recipient data, and supplemental content recipient data with the distribution network 155. The distribution network 155 may comprise a distribution network facility having item processing equipment, such as mail processing equipment, configured to scan or read unique identifiers located on items received into the distribution network facility, to transport, sort, and otherwise process items. In some embodiments, the distribution network 155 may be a computer, a processor, or other similar device in communication with one or more processing apparatuses at distribution network facilities. The distribution network 155 can also include mobile computing devices configured to track resource position and item position, via, for example, a location detection system (GPS, etc.), and to scan items. The mobile computing devices can provide pick-up, location, and delivery data to components of the system 100

In the example of the USPS, the CPDB module 110 will ingest data from multiple sources as described in the sections below. To meet these needs, CPDB module 110 can be a highly available and scalable system to provide on-demand access to various USPS data sources in a reliable and consistent fashion.

The CPDB module 110 is configured to generate, receive, send, and track enhanced digital or supplemental content. This process will be described in greater detail below.

The content interface 125 is in communication, either wired or wirelessly, with the CPDB module 110 and the distribution network 155. The content interface 125 receives and communicates item data, content data, sender information, recipient information, and advertising campaign data with the CPDB module 110. The content interface 125 can receive the above information or content data as from a content provider, such as an advertiser, shipper, sender, or other entity associated with an item to be delivered via the distribution network 155. The content data may comprise the supplemental content, supplemental content item association, item association, budget, advertising impression targets, campaign duration, campaign start date, campaign end date, target audience demographics, and the like. Item association may comprise data associating one or more items with one or more campaigns (for example, marketing and/or advertising campaign), supplemental content pieces, recipients, recipient lists, and the like. The supplemental content may comprise a digital coupon, graphic, video, email, webpage, hyperlink, text message, instant message, social media message, augmented reality display, and the like, as introduced above. Audience demographics data may comprise age, height, weight, gender, socioeconomic status, geographic region, education level, credit score, personal interests, spending habits, and the like. User data may comprise user login credentials, physical addresses such as residential or business addresses, contact information such as phone numbers or email addresses, and the like.

The content interface 125 may reside on various platforms or devices such as a website, a mobile application, a dedicated terminal, or a computer. In some embodiments, the content interface 125 may comprise an application programming interface (API). The content interface 125 is configured to communicate content data and item data to the CPDB 110 via the network 120.

The content interface 125 may be generated by the CPDB module 110 or by a third party, developer, user, or another entity desiring to access the system 100. In some embodiments, the CPDB module 110 allows an advertiser, a commercial user, a utility, financial institution, etc. user to generate a customized content interface 125, which can be made available to the user's customers via a website or mobile application owned or provided by the advertiser user. In this case, the CPDB module 110, in conjunction with provided APIs, may provide an advertiser user access to data from the CPDB module 110 for use on or in the advertiser user's own systems. Users of the content interface 125 may comprise advertising entities and their employees, associates, delegates, computer programs, item recipients, and the like. The content interface 125 may comprise html form fields, data file import fields, and the like.

The distribution network user interface 135 can be in communication, either wired or wirelessly, with the CPDB module 110 and the distribution network 155, for example, via the network 120. The distribution network user interface 135 may receive and communicate item data and content data from the CPDB module 110, and can communicate the item data and the content data to the distribution network 155. The item data may comprise shipping notifications, delivery date estimations, weight, item type, volume, item contents, destination, recipient, item pictures such as external or internal views of an item, item size, or any other desired information relating to the item, and the like. The content data may comprise item association data, recipient data, budget, duration, campaign start date, campaign end date, and the like. Item association data may comprise data associating one or more items with one or more campaigns, recipients, recipient lists, and the like. Recipient data may comprise physical addresses such as a residence or business address, recipient names, recipient contact data such as a phone number or email address. Recipient data may further comprise recipient delivery preferences such as delivery location preferences, delivery time preferences, or whether the recipient rejected, accepted, or postponed the item delivery, and the like. Recipient data may also comprise recipient opt-in information and user interest information as established by the recipient using the recipient user interface 115. The recipient data may also include information about what offers a particular recipient wants to view and/or is willing to share with other recipients.

The distribution network user interface 135 may reside on various platforms or devices such as a website, a mobile application, a dedicated terminal, or a computer. In some embodiments, the distribution network user interface 135 may comprise an API.

The distribution network user interface 135 may be generated by the CPDB module 110 or by a third party, developer, user, or another entity desiring to access the system 100. In some embodiments, the CPDB module 110 may allow a distribution network 155 user to generate a customized user interface, which can be made available to the distribution network's customers via a website or mobile application owned or provided by the distribution network user. Users of the distribution network user interface 135 may comprise distribution network employees, associates, delegates, computer programs and the like.

The recipient user interface 115 is in communication, either wired or wireless, with the

CPDB module 110 and the distribution network 155 and/or other components of the system 100. The recipient user interface 115 may communicate recipient user data, item data, recipient opt-ins, recipient interests, supplemental content data, and the like with the CPDB module 110. Recipient user data may comprise user login credentials, physical addresses such as residential or business addresses, recipient names, and recipient contact data such as phone numbers or email addresses, and the like. Recipient user data may additionally comprise recipient delivery preferences such as desired delivery locations, desired delivery times, whether the recipient rejected, accepted, or postponed the item delivery, and the like. Recipient user data may further comprise supplemental content preferences such as topics of interest, supplemental content delivery preferences, and the like. Recipient user data may also comprise recipient opt-in information and user interest information as established by the recipient using the recipient user interface 115. The recipient user data may also include information about what offers a particular recipient wants to view and/or is willing to share with other recipients.

Users may also enter their preferences for additional information and/or supplemental content that the user wants to receive, including geographic areas, characteristics, or other parameters for a user to receive offers from which are related to items that are physically sent to other recipients. Other recipients may include specifically named recipients that the original recipient wishes to send offers to.

In some embodiments, a recipient may send an offer specifically to another recipient. Item delivery data may comprise a shipping address, email address, or phone number. The recipient may send the offer signed from whom it is coming.

The item data may comprise shipping notifications, delivery date estimations, size, weight, type, volume, dimensions, contents, destination, recipient identification, recipient item preferences, item pictures such external or internal views of an item, or any other desired information relating to the item. Supplemental content may comprise a digital coupon, graphic, video, email, webpage, hyperlink, text message, instant message, social media message, text, and the like.

The recipient user interface 115 may reside on various platforms or devices such as a website, a mobile application, a dedicated terminal, or a computer. In some embodiments, the recipient user interface 115 may comprise an API.

The recipient user interface 115 may be generated by the CPDB module 110 or by a third party, developer, user, or another entity desiring to access the supplemental content system 100. In some embodiments, the CPDB module 110 may allow a recipient user to generate a customized user interface. In this case, the CPDB module 110, in conjunction with provided APIs, can allow a recipient user to access data from the CPDB module 110 for use on or in the recipient user's own systems. Users of the interface 115 may comprise item recipients, supplemental content recipients, and the like. In some embodiments, the user interface 115 can be an application or website, and can display item images and other information, such as in a dashboard format. In some embodiments, the user interface 115 can be an email inbox notification, with clickable images of the items to be delivered, where clicking the images provides access to supplemental content associated with the items being delivered. In some embodiments, the user interface 115 also allows the user to select preferences regarding offers available to the recipient via the user interface 115 (for example, digital offers or items related to mail items in the distribution system. In some embodiments, the user interface 115 allows the recipient access digital offers, for example, via a daily e-mail and/or browse offers that are currently available (for example, associated with mail items in the distribution system or mail stream. In some embodiments, the recipients can also adjust preferences to receive digital and/or physical mail from various entities.

The item sender user interface 140 is in communication, either wired or wirelessly, with the CPDB module 110 and the distribution network 155. The item sender user interface 140 communicates item data with the CPDB module 110. The item data may comprise shipping notifications, delivery date estimations, item pictures, item dimensions, item weight, item delivery address, and the like. Users of the item sender user interface 140 may comprise item senders, retailers, e-commerce merchants, shippers, commercial and individual sellers, and the like. In some embodiments, the item sender user interface 140 may be configured to allow an item sending user to associate physical distribution items, such as a mailpiece, with supplemental content provided via the content interface 125. In some embodiments, the item sender user interface 140 and the content interface 125 can comprise a single interface. This process will be explained in greater detail below.

In some embodiments, the item sender user interface 140 can include instructions on sending supplemental content to users of the system 100 according to their preferences. For example, an item sender who is sending an item of home electronics to a particular recipient who ordered the item, can request that the supplemental content or offer be sent to those within a certain geographic area, or who have selected particular preferences, or who have ordered similar items in the past. The other users can then see the supplemental content via their interfaces or accounts.

The item sender user interface 140 may reside on various platforms or devices such as a website, a mobile application, a dedicated terminal, or a computer. In some embodiments, the item sender user interface 140 may comprise an API.

The item sender user interface 140 may be generated by the CPDB module 110 or by a third party, developer, user, or another entity desiring to access the supplemental content system 100. In some embodiments, the CPDB module 110 may allow an item sending user to generate a customized user interface, which can be made available to an item sending user's customers via a website or mobile application owned or provided by the item sending user. In this case, the CPDB module 110, in conjunction with provided APIs, can allow an item sending user to access data from the CPDB module 110 for use on or in the item sending user's own systems.

In some embodiments, the advertising data communicated by the content interface 125 with the CPDB module 110 may comprise internet address that references the storage location of the advertising data. For example, the advertising data may comprise an internet address referencing at least one image stored on a content delivery network. The referenced images may comprise an external view of the mail item being sent, such as the front and/or back of the mail item, an image of any portion or all of the parcel, flat, letter, etc., the contents of the mail item, or any other image that the advertiser wishes to associate with the mail item. The advertising data may additionally comprise one or more internet addresses, computer readable codes, etc. referencing or encoding supplemental content that is associated with the mail item. The internet addresses may comprise uniform resource locators, internet protocol addresses, and the like. In this case, the CPDB module 110 can access and store the supplemental content referenced in the internet address using protocols such as file transfer protocol, hypertext transfer protocol, secure shell transfer protocol, secure file transfer protocol, and the like.

The system can also include an anonymized image of the item. For example, the recipient of the physical item will generally receive an image of the actual item intended for delivery to the recipient, such as the image taken on item processing equipment as the item was processed. In the case of an additional recipient, or a user to whom the item is not to be physically delivered, this user's dashboard, account, application, etc., may show an image representative of the item received by the actual item recipient, but, for privacy, will not show the image of the actual item taken on the mail processing equipment. In this case, the sender can provide an anonymized or generic image of the item, which lacks, for example, recipient name and address information or on which the recipient name and address have been removed or obscured. In some embodiments, the system can redact or remove any identifying information on the image of the item before making the image available to an entity or party other than the recipient of the physical item, for example by removing or redacting name or address information. When the supplemental content associated with that item is provided to the additional recipient, the anonymized image or replacement image is provided.

In some embodiments, the content interface 125 may send the advertising data to the CPDB module 110 using a DAT or XML file format. For example, in a postal service the data may be formatted as a mail.dat or mail.xml file.

In some embodiments, the CPDB module 110 can associate supplemental content with items sent by a third-party item sender. The supplemental content can be accessed by clicking on, tapping on, or otherwise selecting the image of an item. The supplemental content can reroute a user to a website, can apply a coupon or discount code for ordering products, can be an audio or video feature. In some embodiments, the supplemental content can provide an augmented reality experience, a virtual reality experience, can display a holographic message, sound, movie, and the like. The augmented reality and virtual reality content can be accessed using a mobile computing device or virtual reality hardware or devices. The supplemental content may include the digital content of the offer that the recipient opts-in to view and/or access.

As one example of supplemental content, a health food advertiser can create an advertising campaign that associates the health food advertiser's supplemental content, via the CPDB module 110, with a physical mail piece sent by a health food store, franchisor, franchisee, or other similar entity. After associating the supplemental content, the CPDB module 110 can then distribute the supplemental content to the item recipient. In this case, the distribution network 155 may provide compensation to the third-party item sender such as free shipping, discounted shipping, or a discount coupon in exchange for the supplemental content being associated with their item. Alternatively, the distribution network 155 may provide compensation to the item recipient in exchange for receiving and interacting with the supplemental content advertisement. In some embodiments, the health food advertiser may compensate the item sender or the item recipient in exchange for the supplemental content being associated with the item. In some embodiments, when the recipient opts in to see offers from the health food store, and so forth, the recipient may have access to advertisements generated for the health food advertiser's advertising campaign, for example online coupons or advertisements.

In some embodiments, the CPDB module 125 may generate a supplemental content recipient list and distribute supplemental content to that list without any item association. In this case, the CPDB module 110 can generate the supplemental content recipient list using data from past supplemental content recipient lists, email lists, instant message user lists, direct message user lists, social media user lists, and the like. Supplemental content recipients may receive a commission, discount coupons, or other form of compensation in exchange for receiving and interacting with the supplemental content. The CPDB module 125 may also receive a list of recipients to whom offers are shared by another recipient.

In some embodiments, the content interface 125, and any other interface described herein, may additionally provide an advertiser user with configurable dashboards, reports, queries, and alerts. The content interface 125 may be configured to allow the advertiser user to analyze, manipulate, or trend data regarding the advertiser user's sent items, the advertiser user's supplemental content, and the advertiser user's advertising campaign settings, in whatever way the user wants. The content interface may allow customization of system preferences, including options to set delegation access in profile settings, manage subscriptions, navigate to other distributor, carrier, or shipper webpages, and view favorite queries and reports. In some embodiments, the content interface may allow customization such that recipients that opt-in to receive offers receive specific offers based on identified interests.

The recipient user interface 115 can display to a recipient, such as a registered recipient, images of mail pieces or items that are intended for delivery to the recipient on a certain day or within a certain time period. The recipient user interface 115 can also display to an opted in recipient digital offers that correspond to offers that are current available to the recipient. In some embodiments, the offers correspond to those associated with mail items in the mailstream. The recipient user interface 115 can also display offers to other recipients recommended by another recipient. That is, a recipient of a physical item who also receives supplemental content associated with the item or sender of the item, or a recipient who receives supplemental content associated with the item or from the sender of the item, can identify additional individuals to whom the supplemental content should be sent. The recipient can select from a contact list, from social media followers or friends, or can input individual names. If the CPDB 110 contains profiles for those individuals, the supplemental content or offer can be sent to those selected. In some embodiments, the system can provide the supplemental content to a group of others that are within the same geographic area as the recipient of the physical item, and/or which have preferences stored which align with, match, or are associated with the physical item. Such a provision may be automatic when the recipient and/or the group of others opt in for such provisions or may be manually selectable by the recipient and/or the group of others.

The recipient user interface 115 may also allow the recipient to directly update records based on the recipient's interests and desires, for example opting in to receive advertisements regarding health food stores or hiking. These preferences can be added to a user's profile in the CPDB 102.

The distribution network 155 can provide data regarding items to be delivered on a day or within a time period to the CPDB 110. The CPDB 110 can identify which of the items to be delivered have supplemental or enhanced digital content associated with them. For items with which the CPDB 110 has supplemental content or enhanced digital content, images of those physical items are provided to the recipient user interface 115 for the specific recipient of the physical item or items. The recipient user interface 115 can provide these images in an email, via an application, a website, and the like.

The supplemental content feedback data may comprise time spent viewing the content, mouse clicks, mouse clicks that lead to a purchase of a product or service, mouse hovers, scrolling, tapping, dragging, sharing the content via social media, forwarding the supplemental content via email, forwarding the supplemental content via text message, forwarding the supplemental content via instant message, re-posting the supplemental content on a webpage, embedding the supplemental content on a webpage, indicating appreciation of the content, and the like.

USPS.265A PATENT

In some embodiments, the recipient user interface 115 may provide the recipient user with configurable dashboards, reports, queries, and alerts. The recipient user interface 115 may be configured to allow the recipient user to analyze, manipulate, or trend data regarding the recipient user's items and the recipient user's supplemental content, in whatever way the recipient user wants. The recipient user interface 115 may be configured to allow the recipient user to customize system preferences, including options to set delegation access in profile settings, manage subscriptions, navigate to other distributor, carrier, or shipper webpages, and view favorite queries and reports. In some embodiments, the recipient user interface 115 can provide additional functionality including buttons, links, or other features. For example, where the item is an advertisement, the additional functionality can be a button, link, or input which allows for easy, single click ordering of a product associated with the supplemental content or the item. If the item is a bill, such as a credit card or utility bill, the recipient user interface 115 can include a button or link for easy or quick paying of a bill, without the need to navigate to a separate website. Clicking the button may generate a pop-up menu for paying. In some embodiments, the recipient user interface 115 can provide additional functionality such as online voting, ordering/sending money orders, buying stamps and postage, or other functions. The recipient user interface 115 may allow the recipient to select preferences, browse and/or save offers and/or deals associated with mail items in the mailstream, items in the mailstream intended for other recipients, and receive digital items from entities. In some embodiments, the recipient may receive notifications of available offers based on the preferences selected by the recipient during or after the opt-in.

In some embodiments, the recipient user interface 115 may enable a recipient user to choose various topical categories of personal interest such as hobbies, favorite movies, favorite books, favorite sports, and the like. In this case, the CPDB module 110 may use these topic choices to determine which items and supplemental content to send to the recipient user. For example, the recipient user may choose topical interests such as exercise, health food, and movies. The CPDB module 110, based in part on these recipient user choices, may then add this recipient user to various item mailing lists and supplemental distribution content lists, such as lists for gym membership advertisements, health food store advertisements, and movie theater advertisements. The recipient user interface 115 may be additionally configured to enable the recipient user to prevent item delivery and supplemental content delivery regarding certain topics or from a certain

USPS.265A PATENT sender. The recipient user interface 115 may also enable a recipient to identify one or more other recipients with whom the recipient wishes to share an offer or offers.

In some embodiments, the recipient user interface 115 will list items scheduled for delivery to the recipient user or offers available for review. In this case, the interface may list details associated with each item such as dimensions, weight, item sender, item category, pictures of the item, and the like. The CPDB module 110 may classify the items by category such as bills, personal correspondence, bank documents, advertisements, and the like.

In some embodiments, the recipient user interface 115 may enable the recipient user to select an option to accept, reject, postpone, or schedule the delivery of supplemental content for one or more items scheduled for delivery to the recipient user to a one or more other users. The CPDB module 110 may store the recipient user's choice in a user preference database 310, and also communicate that choice with the distribution network 155. In some embodiments, the recipient user interface 115 can communicate the recipient user's item preference data directly to the distribution network 155, such that such preferences are automatically applied in future circumstances.

In some embodiments, the recipient user interface 115 allows a user to send a response to a received mail item or send a digital copy of a received mail item or a received digital item. For example, if the item to be delivered, or which was delivered, is a birthday card, the recipient can, via a feature in the recipient user interface 115, initiate sending a response to the sender, including a personalized message, such as a thank you, etc., and the distribution network will automatically prepare and send the response. The recipient user interface 115 can generate a series of menus that the recipient can walkthrough to generate or create a response to send, which will then be sent by the distribution network.

In some embodiments, the recipient user interface 115 may provide supplemental content which allows a user to automatically purchase an item and have the item shipped to an address on file in the user account. This can occur when a user clicks or taps on an image of a mailpiece, or when a user accesses an offers portion of an account, application, website, or the like,.

In some embodiments, the CPDB module 110 may distribute supplemental content, to an item recipient, comprising a digital discount coupon in a text message. The item recipient may forward the text message to third parties such as friends, family members, or associates. These third parties can interact with the supplemental content using a third-party text message interface.

USPS.265A PATENT

These interactions may comprise clicking or tapping on the digital discount coupon to redeem it online, printing the discount coupon, saving the discount coupon, and the like. The third-party interface may then communicate the interaction data to the CPDB module 110 using an API, embedded content, a remote database connection, file transfer protocol, secure file transfer protocol, a secure shell connection, and the like.

In some embodiments, the CPDB module 110 may distribute supplemental content, to an item recipient, comprising a digital discount coupon in an instant message. The item recipient may forward the instant message to third parties such as friends, family members, or associates. In some embodiments, the system 100 may identify additional recipients within a geographic area, or who have similar preferences, meet particular criteria based on the item being sent, or have requested additional information, and may send the supplemental content to these additional recipients.

These third parties or additional recipients can then interact with the supplemental content using a third party interface, by receiving the supplemental content embedded, linked, or otherwise provided in an email, in a text message, in an inbox of an account, via a mobile application, and the like. Some interactions may comprise clicking or tapping on the discount coupon to redeem it online, printing the discount coupon, saving the discount coupon, and the like. The interface can then communicate the interaction data to the CPDB module 110 using an API, embedded content, a remote database connection, file transfer protocol, secure file transfer protocol, a secure shell connection, and the like.

In some embodiments, the CPDB module 110 may distribute supplemental content, to an item recipient and/or to additional recipients, comprising a digital discount coupon in embedded content on a webpage. The item recipient may then forward the embedded content to third parties such as friends, family members, or associates. These third parties can then interact with the supplemental content using a third party internet browser. These interactions may comprise clicking or tapping on the discount coupon to redeem it online, printing the discount coupon, saving the discount coupon, and the like. The internet browsing interface can then communicate the interaction data to the CPDB module 110 using an API, embedded content, a remote database connection, file transfer protocol, secure file transfer protocol, a secure shell connection, and the like.

In one example, the health food advertiser provides the content interface 125 with advertising data relating to a new organic egg advertising campaign. After receiving the data, the CPDB module 110 generates a recipient list based on audience demographic data selections and campaign data received from the content interface 125 input by the health food advertiser. The health food advertiser may also choose to associate with the campaign one or more mail item or mail item types for delivery by the distribution network. The recipients may be chosen based on recipient or preference information stored in the CPDB 110. To illustrate, the CPDB may select to send the supplemental content to recipients who have previously purchased items from the health store or other similar health stores, people who subscribe to magazines related to food or organic food, high-income recipients, who live within a geographical area from the health store, people who buy running shoes, or any other desired recipient information.

In some embodiments, the content interface 125 provides an offer to the recipient via the recipient user interface 115. In some embodiments, the offer includes an image that mimics the corresponding physical mail item. The offer may also include an enticement, for example a coupon, discount, or other “call to action” that may drive engagement with the offer. For example, the “call to action” may comprise an interactive link, image, activity, and so forth through which the user may interact with the offer. In some embodiments, the offer also includes a link to a digital website or corresponding offer site. The offer may be customized to a particular recipient or recipients. In some embodiments, the offer may include options associated with a previous mail item from the entity. For example, when associated with a package notification, the offer allows the recipient to initiate a prompt return of an item or to view a manual, specification, reviews, customer service information, instructions, or so forth associated with the item.

In this case, the health food advertiser entered into the user interface 125 audience demographic data selections consisting of recipients who live in the city of San Diego, have indicated a previous interest in the topics of exercise and health food, and have a purchase history of buying organic food products. The content interface 125 allows the health food advertiser in this example to select these categories through a variety of options such as dropdowns menus, check boxes, radio buttons, text fields, text areas, auto-fill text fields, and the like. The health food advertiser may choose to limit the total number of recipients in this group to a set number or to a percentage of the total available recipients matching the demographic data. In addition to demographic data, the health food advertiser can associate supplemental content with the campaign via the content interface 125. The supplemental content in this example may comprise a hyperlink to a digital discount coupon for discounted organic eggs.

After receiving the campaign data, the CPDB module 110 will associate the supplemental content with the item recipient list and distribute the supplemental content to the recipients in the recipient list. Each item recipient in this example will receive an email or text message or other alert notification regarding the shipped item. The notification will include the supplemental content hyperlink. The supplemental content may additionally comprise an image or text describing the discount offer. The recipient can interact with the notification using an email or text message interface. If the recipient clicks or taps on the discount coupon hyperlink, the health food advertiser will be charged for the interaction. In some embodiments, the health food advertiser may pay for each 1000 impressions of their supplemental content. In some embodiments, the health food advertiser may pay for each time a recipient redeems the coupon by purchasing organic eggs.

In some embodiments, the campaign data changes may be made by the health food advertiser after each round of supplemental content distribution via the content interface 125 or by a third-party user interface. For example, the health food advertiser may configure their organic egg advertisement campaign to stagger distribution. After each round of distribution, the CPDB module 110 may pause the campaign and notify the health food advertiser regarding the campaign status. The health food advertiser can then view, using the advertising user interface 125, statistics regarding recipient interaction with the most recent group of distributed supplemental content. In this example the advertiser may notice that their supplemental content campaign has a fifty percent higher click rate with middle-aged recipients. The health food advertiser can then alter their campaign list to exclusively target those particular recipients. After finalizing the campaign changes, the health food advertiser will then un-pause the campaign, and the CPDB module 110 will begin distributing another round of supplemental content according to any changes made by the health food advertiser. In some embodiments, the campaign data changes from this example may be made automatically by the CPDB module 110 and then approved by the advertiser user via the content interface 125 or by a third-party user interface. The potential users of the supplemental content system are not limited to health food advertisers. For example, a national advertiser such as a department store chain may decide to promote a holiday sale via the supplemental content system. In another example, an online streaming music service may utilize the system to generate more users through a supplemental content advertising campaign offering a free week of streaming music in exchange for filling out an online contact form. In yet another example, a local government agency could utilize the supplemental content system to spread a public service announcement regarding the importance of conserving water during a drought. In this example, the supplemental content could be associated with mail items such water bills or lawn care supplies. The supplemental content can be accessed by clicking or tapping on the image of the water bill displayed in the recipient user interface 115.

### Informed Delivery and Informed Offers

In some embodiments, the recipient receives a notification (for example, a digital notification) of physical mail items that the recipient has received or will receive. In some embodiments, the notification may comprise information related to the physical mail item. For example, the notification may include instructions or information related to the physical mail item (for example, a link to installation instructions, item specifications, or a user manual). In some embodiments, the notification includes instructions or recommendations regarding returns or rejections of delivery of the item, and so forth. In some embodiments, the recipient may view images of previously received physical mail items. In some embodiments, the notifications may be coordinated with the delivery of the physical mail items and/or supplemental content.

The notification may provide the recipient with knowledge of items to expect as well as provide the sender an opportunity to communicate additional information to the recipient easily and quickly. Thus, the sender may use the notification as an opportunity to add digital content to the mail sent to the recipient. In some embodiments, the digital content includes a “call-to-action” and/or a website address. In some embodiments, the recipient may use the digital content to correspond with the sender regarding the item (for example, via a linked e-mail address or “contact us” website).

In some embodiments, an entity, or potential recipient can access his or her own account, informed delivery dashboard, or interface via the recipient user interface 115. In the recipient user interface 115, an entity can identify categories or preferences for which the entity would like to receive supplemental content for items delivered within a geographic area, such as an area encompassing the residence or address of the entity. The entity can browse the recipient user interface 115 and identify an option to view offers that are available in the recipient's area that are associated with physical items which were distributed to others and/or an option to provide offers that the recipient received to others. An offer may be an online or digital version of an original physical or digital advertisement or other flyer distributed through a physical mailer, a digital mailer, or physical and digital mailers. The physical mailer may comprise a physical mail item that the recipient receives in a mailbox or similar physical receptacle or receiving box. The digital mailer may comprise a digital mail item that the recipient receives via a digital mailbox or the receiver user interface 115 automatically, for example, without manually requesting to receive the digital mailer. The original physical or digital advertisement may be distributed to at least one neighbor recipient in the recipient's area. In some embodiments, the recipient also receives the physical or digital mailers. In some embodiments, the recipient only receives the offers for mailers that the recipient did not receive. The offer may be available to the recipient online or digitally through the recipient user interface 115 upon the recipient opting-in to receive the offer or offers in general.

In some embodiments, the recipient receives an email, a text message, an application notification, or the recipient browses the recipient user interface 115 and identifies an option to view offers that are available in the recipient's area. The offer may be an online or digital version of an original physical or digital advertisement or other flyer distributed through a physical mailer, a digital mailer, or physical and digital mailers. The physical mailer may comprise the mail item, introduced above, that the recipient receives in a mailbox or similar physical receptacle or receiving box. The digital mailer may comprise a digital mail item that the recipient receives via a digital mailbox (for example, an email or similar client) or the receiver user interface 115 automatically, for example, without manually requesting to receive the digital mailer. The original physical or digital advertisement may be distributed to at least one neighbor recipient in the recipient's area. In some embodiments, the recipient also receives the physical or digital mailers. In some embodiments, the recipient only receives offers corresponding to digital or physical mailers that the recipient did not receive. The offer may be available to the recipient online or digitally through the recipient user interface 115 upon the recipient opting-in to receive the offer or offers in general.

In some embodiments, the recipient opts-in to receive the offer or offers in general. When the recipient opts-in to the offers in general, the recipient may be able to view all of the offers available without having to opt in for each individual offer. When the recipient opts-in to

USPS.265A PATENT individual offers, the recipient may have not be able to view a particular offer until they opt-in to view the particular available offer. The offer or offers may be available to the recipient only digitally through the recipient user interface 115 or digitally and physically (for example, the recipient can request a physical copy of the offer or mailer) upon request to view the offer. For example, the neighbor recipient receives a physical and/or a digital coupon for pet supplies and golf equipment while the recipient receives no such physical or digital coupons. However, the recipient may have an opportunity to opt-in to view offers corresponding to advertisements or flyers (digital or physical) received by neighbor recipients, for example the pet coupons and the golf equipment coupons. In some embodiments, the recipient opts-in to each of the pet and golf equipment coupons individually or to all offers (including both the pet and the golf equipment coupons) at once. In some embodiments, the recipient can opt-in to receiving and viewing all offers received by all neighbor recipients or a specific offer on an offer-by-offer basis.

When the recipient opts to view the specific offer or all offers, the recipient user interface 115 may display to the recipient a copy of the digital coupon for the pet supplies and/or the golf equipment. In some embodiments, the recipient user interface 115 also displays to the recipient the neighbor recipient(s) that received the original coupon, the source for the original coupon, relevant dates, and so forth. In some embodiments, the recipient user interface 115 provides these details regarding the original coupon(s) to the recipient before the recipient selects to view the offer(s). For example, the user interface 115 provides the recipient with information for the sender (or source) of the offer (for example, the pet store or company providing the coupon), the neighbor recipient that received the original mailer, a product subject or category with which the offer is associated, and so forth.

In some embodiments, the offer includes links to the digital coupons or other items or products associated with the offer (for example, the source website, etc.). As noted above, the offer may include an option for the recipient to request a physical coupon associated with the offer, order the same item as the was ordered by the neighbor or other entity, and have the item shipped to the recipient. The CPDB 102 may store the recipient's preferences. For example, when the recipient requests to view the offer or requests a physical coupon associated with an offer, the CPDB 102 stores the recipient's selection in the CPDB 102. In some embodiments, the recipient's selections stored in the CPDB 102 are communicated to companies or businesses associated with the offers viewed by the recipient. In some embodiments, the recipient's selections are not stored in the CPDB 102 but the recipients accessing of the offer is communicated directly to the company or business associated with the offer viewed by the recipient. In some embodiments, the CPDB 102 stores the recipient's selections and uses the recipient's selections to route future physical and/or digital mailers to the recipient automatically for associated categories, companies, neighbor recipients, and so forth. For example, the recipient may opt-in, through the recipient user interface 115, to receive future physical mailers, digital mailers, or physical and digital mailers associated with a particular offer. The recipient user interface 115 may allow the recipient to receive future mailers from the same company or sender as the viewed offer, receive future mailers in the same product category as the viewed offer, receive future mailers send to the same neighbor recipient as the viewed offer, and so forth. Additionally, the recipient may use the recipient user interface 115 to determine what information is shared with a particular mailer, for example what information, if any, beyond recipient interests are shared.

The prompt to the recipient requesting that the recipient “opt in” to viewing offers that other recipients in the recipient's area are receiving may take one of many forms. For example, the recipient user interface 115 presents the recipient with a pop-up “Yes/No” prompt or a selection box to indicate that the recipient does opt in to receiving indications of offers that are being presented to other recipients in the area.

In some embodiments, the sender may have two tiers of offers available to be viewed by two different groups of recipients. The first tier of offers may be available to recipients that have been previous customers of the sender and thus their offer is of greater value than the second tier recipients who may be first time purchasers.

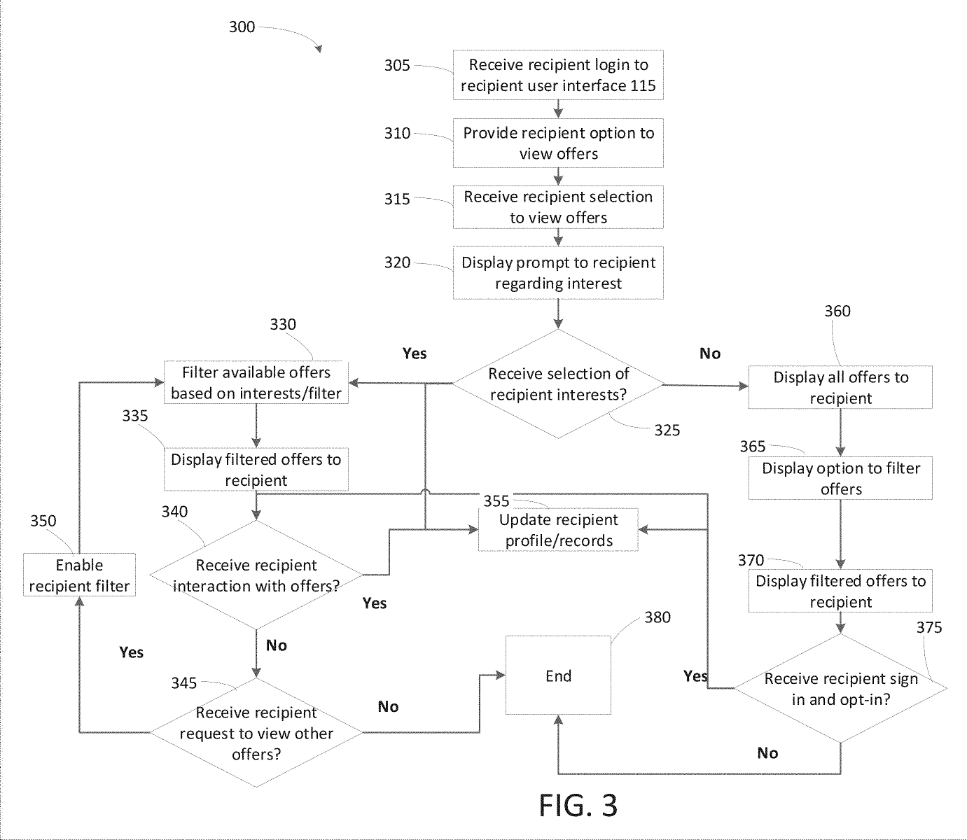

FIG. 3 shows a flowchart for a method 300 of viewing offers associated with items received by another recipient, such as a neighbor, relative, friend, etc. As used herein, the term neighbor can refer to another entity living within the same geographical areas the recipient who receives a physical item, to recipients of physical items who have the same or similar characteristics as the recipient, and other entities who receive physical distribution items.

The method 300 begins at block 305 with the recipient logging into the recipient user interface 115. For example, this may comprise the recipient logging into the recipient's account for informed delivery or other services provided by the distribution system 100. In some embodiments, this may occur when the recipient selects an option provided in an email, a text message, an application, and the like.

The method 300 moves to block 310, wherein the recipient user interface 115 provides the recipient with an option to view available offers corresponding to mailers received by the recipient or one or more neighbor recipients in the general geographic area (e.g., the neighborhood) of the recipient. In some embodiments, the system can send the supplemental content to anyone within a ZIP+4, or a ZIP code, as desired, who meets the criteria, or who desires to see which offers have been sent to others. That is, a user may only be able to see the supplemental content and offers sent to someone in their own ZIP+4, or ZIP code in their own account, application, dashboard, etc. In some embodiments, the recipient has viewed the offers and a selection of the offers initiated the login to the recipient user interface 115. In some embodiments, the option to view available offers or supplemental content comprises a pop-up or similar selector to the recipient via the recipient user interface 115. In some embodiments, the option to view comprises a tab to show a different screen or a selector box or another similar option.

The method 300 moves to block 315, wherein the recipient user interface 115 receives the recipient's selection to view available offers. In some embodiments, the receipt of the recipient's selection to view offers is interpreted as the recipient “opting-in” to view/receive offers. In some embodiments, the option at block 310 is an affirmative prompt to the user to opt-in to viewing offers. For example, the recipient user interface 115 prompts the recipient to opt-in to viewing (for example, selecting or viewing in more detail) all of the offers displayed. In some embodiments, the recipient is presented with a Yes/No prompt or similar opportunity to opt-in to viewing available offers. In some embodiments, the recipient sees offers for items sent to other recipients in a daily communication, such as an email, text message, etc., which the user does not need to specifically initiate.

The method 300 moves to block 320, wherein the recipient user interface 115 displays a prompt to the recipient to identify recipient interests. In some embodiments, a list of available interests is presented to the recipient via images, a drop down menu, or the like. It will be understood that this step, and one or more other steps need not be performed in the method 300.

The method 300 moves to decision state 325, wherein the recipient user interface 115 determines whether it receives a selection of interests from the recipient. If the recipient opts-in or has previously opted in to viewing some or all the offers at block 315 and provides interests according to which the offers are filtered, the method 300 proceeds to block 330.

At block 330, the recipient user interface 115 filters all available offers based on the recipient interests, for example, all those offers associated with items that have been sent to other recipients within a geographic area, friend/family group, etc. At block 335, the recipient user interface 115 displays the filtered offers to the recipient. The results are filtered according to recipient preferences, and according to profile information in the CPDB 102, and categories that have been provided by or determined by the system 100. In some embodiments, the displayed offers are provided to the recipient via a list, drop down menu, tiled arrangement, or similar means. In some embodiments, the display of filtered the offers includes details or information about the offers (for example, corresponding company, available discounts/coupons, and so forth), as described above.

At block 335, the recipient is able to select and view any offer presented. If the recipient interacts with any presented offer via the recipient user interface 115 (for example, clicking on an associated link or saving an offer for viewing later) at decision state 340, then the method 300 updates the recipient's profile and/or records at block 355 and then determines whether the recipient wishes to view additional offers at decision state 345. If the recipient user interface 115 does not receive recipient interaction with the filtered offers at block 340, then the method 300 determines whether the recipient wishes to view additional or other offers at block 345. If the recipient does wish to review other offers, then the method 300 proceeds to block 350 where the recipient can customize filters applied to available offers, and the method 300 repeats from block 330 based on the recipient provided filters at block 350 and not tied only to the recipient interests.

In some embodiments, the recipient user interface 115 may receive a recipient request to review offers without receiving an opt-in from the recipient at block 315 or without receiving a selection of recipient interests at decision state 325. Instead, the recipient may choose to review all available offers in the recipient's neighborhood or may filter based on interests that are not saved relative to or related with the recipient. Thus, the method 300 may proceed to block 360 and display all available offers to the recipient via the recipient user interface 115. For example, the available offers may be displayed in a list, a tiled arrangement, a drop down menu, and the like. In some embodiments, the method 300 provides the recipient with an option to filter the offers, for example based on interests, discount available, location, and the like. At block 365, the recipient user interface 115 may provide the recipient with an option to filter the available offers based one or one or more options (for example, industry, price, and so forth). At block 370, the method 300 may involve displaying the filtered offers to the recipient. At block 375, the method may receive a request from the recipient to sign in or opt-in (for example, to save an offer or to save a search for offers). If the recipient does sign in at block 375, then the method 300 proceeds to block 340, where the recipient user interface receives a recipient interaction with an offer (for example, saves an offer for later viewing) or saves items (for example, interests) in the recipient's profile or records at block 355. After displaying the filtered offers to the recipient via the recipient user interface 115, the recipient user interface 115 may also update records associated with the recipient in the CPDB 102 to store the association with the viewed offers and the opt-in status for the recipient, at block 355. If, at decision state 375, the recipient does not opt in to the informed offers, then the method 300 terminates at block 380. In some embodiments, as described herein, the CPDB 102 also stores the recipient's interest in the offer for communication to the company associated with the offer or for use in future distributions of similar physical or digital mailers. After the recipient views and interacts with the offer at block 340, the method 300 may repeat from 330-350 based on recipient selections to review additional offers. The method 300 may repeat these blocks until all offers are reviewed and/or the recipient no longer selects to view additional offers.

Following blocks 335 and/or 370, the recipient may select an individual offer from the offers displayed to the recipient. At block 370, since the recipient has not opted in to viewing informed offers, the method 300 may provide the recipient with the prompt to opt-in specifically to the selected offer (not shown in this figure). In some embodiments, when the recipient is provided with the prompt to opt-in to the selected offer, the recipient is provided with details or information about the offer (for example, corresponding company, and so forth). If the recipient opts-in to view the offer, then the method 300 may update the recipient's profile (not shown explicitly in FIG. 3).

In some embodiments, the recipient user interface 115 also provides the recipient an opportunity to opt-in to providing offers corresponding to physical or digital mailers or coupons that the recipient receives to neighbor recipients in the area as offers. For example, if the recipient receives the coupon for a sale on pet supplies (either a physical coupon or an electronic or digital coupon), then the recipient can opt in to provide that coupon to other recipients in the recipient's area as an offer. Alternatively, the recipient that receives the coupon for the sale on pet supplies can opt not to provide the offer to any neighbor recipients. In some embodiments, the recipient opts to share all coupons on a coupon-by-coupon basis, thereby enabling the recipient to choose which offers to share with its neighbors. In some embodiments, when the recipient opts to share a selected offer with other recipients, the CPDB 102 (or another component, for example the campaign management module 113 or external data sources 109) verifies whether the selected offer qualifies to be shared with other recipients. In some embodiments, verifying whether the selected offer qualifies to be shared comprises determining that a source of the recipient's offer was one or more of: (1) selected to distribute the offer to more recipients than just the original recipient, (2) purchased a service enabling the offer to be distributed to more than one recipient, and (3) appropriate to deliver to other recipients.

In some embodiments, the system 100 sends a notification, alert, email, text, etc., to the recipient automatically based on preferences previously established by the recipient. For example, when the distribution network is to deliver an item to the recipient of the physical item, the system 100 identifies additional recipients based on the preferences and characteristics selected by the users, the senders of the items, or both. The additional recipient receives a supplemental content or offer message from the system at the same time, on the same day, or when the recipient of the physical item gets the supplemental content. This, in some embodiments, can be the day the physical item is to be delivered to the recipient.

In some embodiments, the sender or the distribution network can send the supplemental content to additional recipients or make the supplemental content available to other recipients only after the recipient of the physical item has received the item, as indicated by a scan of the item upon delivery. In some embodiments, the sender or the distribution network can send the supplemental content to the additional recipients only after the recipient of the physical item or intended recipient of the physical item has interacted with the supplemental content.

In some embodiments, when the recipient opts to provide offers to neighbor recipients, the recipient can opt not to provide the recipient's personal information (for example, recipient name, address, and so forth) to the neighbor recipients. In this way, the recipient can maintain its privacy while enabling its neighbor recipients to enjoy offers similar to the coupon the recipient received. In some embodiments, the system 100 is configured not to provide any personally identifiable information to any additional recipients in order to maintain the anonymity or privacy of the recipient of the physical item.

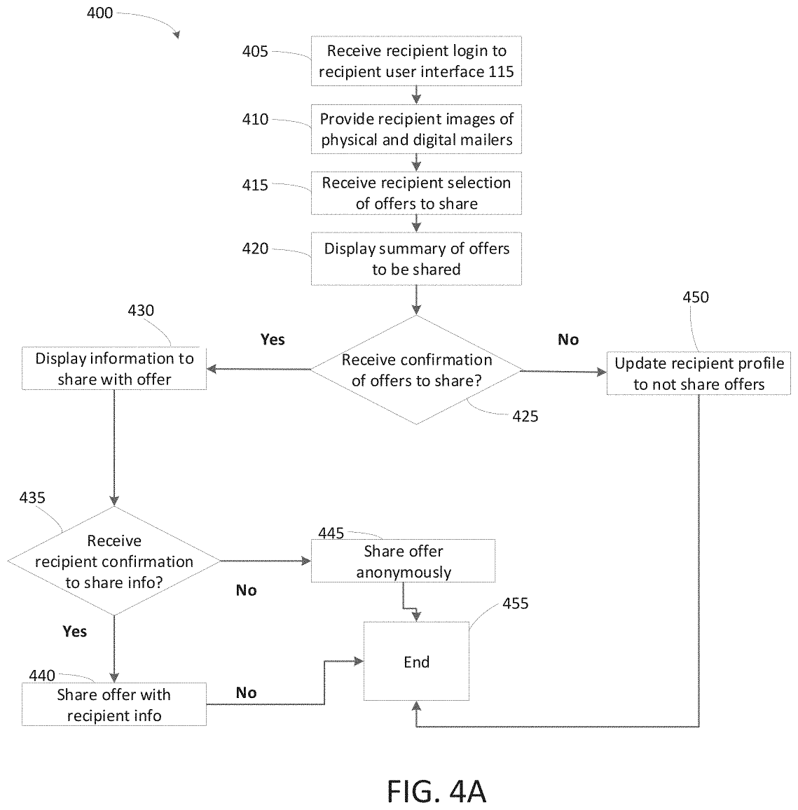

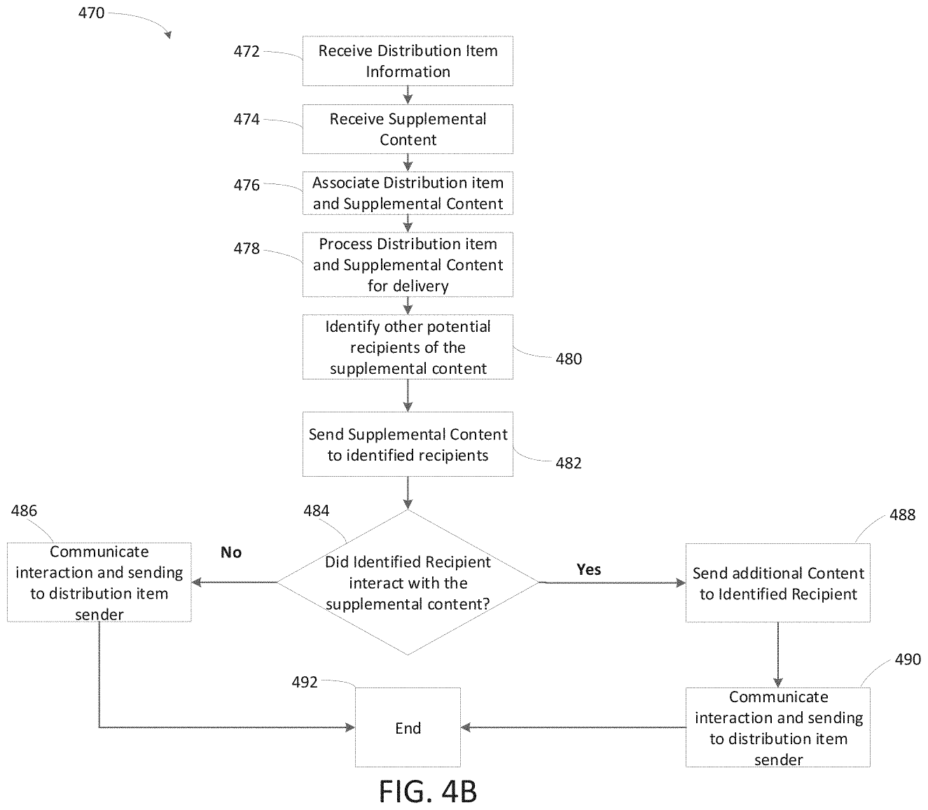

FIG. 4 shows a flowchart for a method 400 of viewing mailers and sharing offers associated with the mailers received by the recipient with neighbor recipients. The method 400 beings at block 405 with the recipient logging into the recipient user interface 115. At block 410, the recipient user interface 115 presents the recipient with the physical and digital mailers that the recipient has received or will soon receive. In some embodiments, the recipient views digital images of the physical and digital mailers and selects the digital images to select a particular mailer. The digital images may include links or interactive components that the recipient can access to learn more about the corresponding mailer and so forth.

The recipient user interface 115 may provide the recipient with an option to select one or more of the mailers (for example, via the digital images) to share with neighbor recipients as offers. In some embodiments, the recipient can also select details regarding the neighbor recipients with whom the offers are shared (for example, specific named neighbor recipients, addresses for specific neighbor recipients, specific streets, and so forth). In some embodiments, offers and items can be shared with neighbor recipients without a first recipient needing to share them. The system can automatically provide offers and items to neighbor recipients upon delivery of the physical item or supplemental content to the first recipient. These offers and items can be shared with neighbor recipients that meet criteria or who have preferences that are related to or which match those associated with the physical distribution item.

At block 415, the recipient user interface 115 receives the recipient's selection of mailers for which corresponding offers will be provided to neighbor recipients. At block 420, the recipient user interface 115 displays a summary of the selected mailers that will be shared with neighbor recipients. At block 425, the recipient confirms whether to share the offers with the neighbor recipients or not. If the recipient opts not to share the offers, then the method 400 may proceed to block 450, where the CPDB 102 is updated with recipient preferences to not share offers. In some embodiments, the CPDB 102 is updated for mailers similar to the selected mailers to show that the recipient does not want to share offers for those mailers. In some embodiments, the CPDB 102 makes associations to show that the recipient does not want to share any offers or offers associated with particular companies, senders, and so forth. In some embodiments, though not shown in FIG. 4, the recipient user interface 115 prompts the recipient regarding whether to update preferences in the CPDB 102 regarding the recipient's selection. If the recipient opts not to update preferences, then the method 400 skips block 450 and proceeds to end at block 455.

If the recipient opts to share the offers at block 425, then the method 400 may proceed to block 430, where the recipient user interface 115 displays information that can be shared with the neighbor recipient(s) when the offer is shared. In some embodiments, this information may include the recipient's name, address, or other identifying information for the recipient. At block 435, the recipient confirms whether or not the recipient information is included when the offer is shared. By including the recipient information, the recipient may indicate to neighbor recipients that the recipient is interested in receiving offers for similar companies, goods, etc., as associated with the offers the recipient is sharing. If the recipient opts to share recipient information at block 435, then the method 400 proceeds to block 440, where the offer is shared with the recipient information. If the recipient opts to share the offer without sharing information at block 435, then the method 400 proceeds to block 445, where the offer is shared anonymously. After blocks 440 and 445, the method 400 ends when the offers are shared. In some embodiments, when the recipient opts to share offers at block 425, the CPDB 102 is updated with recipient preferences to share offers. In some embodiments, the CPDB 102 is updated for mailers similar to the selected mailers to show that the recipient does want to share offers for those mailers. In some embodiments, the CPDB 102 makes associations to show that the recipient does want to share any offers or offers associated with particular companies, senders, and so forth. In some embodiments, though not shown in FIG. 4, the recipient user interface 115 prompts the recipient regarding whether to update preferences in the CPDB 102 regarding the recipient's selection. If the recipient opts not to update preferences, then the method 400 skips block 450 and proceeds to share the offers as described above without updating the CPDB 102.

In some embodiments, the prompts described herein comprise a pop-up or similar selector to the recipient via the recipient user interface 115.

In some embodiments, the recipient selection relating to offers to view or share may be integrated with anonymized or anonymizing system, such that the recipient or neighbor recipients cannot be identified by each other. For example, the physical or digital items may include routing or identifying information other than recipient names and/or addresses. For example, the physical or digital items may be addresses using the recipient's phone number, e-mail address, social media handle, a unique barcode or graphic code, encrypted alphanumeric identifier, and so forth. In such a manner, when the recipient opts-in to view an offer, the recipient need not worry about its personal information being shared, because the corresponding company associated with the offer may only receive the recipient's encrypted alphanumeric identifier that cannot be parsed into the recipient's name or address information. Instead, the corresponding company may only receive the identifier that is used to address mail items in the mailstream.

In some embodiments, the recipient that shares offers may be compensated for forwarding an offer or allowing their offers to be forwarded. For example, if the forwarding of an offer leads to a purchase of a service or good, the recipient that forwarded the offer may be compensated by the merchant or entity that sent the initial offer.

In some embodiments, the informed delivery and offers can be provided for both mail items, flats, magazines, packages, and parcels. In the case where the delivery item is a parcel, the sender can receive interaction information for the item and the supplemental content. In some embodiments, the sender can include a return authorization in the supplemental content. When a recipient of the physical item receives a notification that a parcel is to be delivered, the supplemental content provided with the notification can include a link to a returns portal provided either by the distribution network or by the sender. In some embodiments, the notification can include a link to an online catalog, a website for the sender, or any other desired content.

In some embodiments, the distribution network can have an Artificial Intelligence (AI) architecture to support capabilities within the distribution network relating to mining the extensive item tracking data and identifying trends, anomalies, and other potential issues. The AI architecture can support the following capabilities: to classify requests and predict outcomes, for example, to identify packages at risk; to run multiple models to determine the best possible answer to customer and system queries such as combining outcomes from package history, weather data, facility closures, etc.; to interface with back-end systems, for example to be able to open a ticket when the AI detects an issue which requires or may require human intervention; and to augment human problem resolution, for example to identify changes in the current state of a package's delivery such as identifying a relevant new scan event from the data in the distribution network.

FIG. 4B is a flowchart depicting an exemplary method of processing items and supplemental content. A process 470 begins in step 472 where the distribution network receives from an item shipper or sender who wishes to send a physical distribution item to a plurality of recipients (which can be referred to herein as “first recpients”), item information to the distribution network via the item sender user interface 140. The item sender can send an image of the item, addresses for the item, a geographic location where the item will be sent, categorization of the item including which preferences the distribution item is associated with, item type, class of service, item dimensions, etc. This can occur before the actual physical distribution items are provide to the distribution network for delivery, or can occur at around the same time. A processor of the system, such as in the CPDB module 110 or another component of the network 120 can store the item information received form the item sender. The image of the item can include a code, or the physical item itself can have a computer readable code thereon. In some embodiments, the image of the item is a unique image that can be used to uniquely identify a physical distribution item or a plurality of identical physical distribution items. The code or the image or other unique identifier from the item information can be stored for use by the item processing equipment.

The process 470 next moves to step 474, wherein the system receives supplemental content from the item sender via the content interface 125 or another component. The supplemental content can be similar to that described elsewhere herein. Including, for example, offers, discounts, coupons, sample items, copies of the distribution item.

The process 470 next moves to step 476, wherein the processor associates the distribution item with the supplemental content. This can be done by storing an association between the image of the item, the code on or associated with the item, or other identifying part of the item received from the item sender, with the supplemental content.

The process 470 next moves to step 478, wherein the distribution network receives, sorts, transports, and delivers the physical items for delivery to the first recipients identified on the physical distribution items. As the item processing equipment processes items, the items canb e imaged and/or scanned by an imaging and/or scanning device. The imaging/scanning device can read the code on the item, or can identify a code associated with the item based on the image of the item, using scanned or read addresses, anonymized addresses, barcodes, etc., as described elsewhere herein. The item processing equipment can identify the scanned item as having supplemental content associated therewith.

The supplemental content is delivered to the recipients of the distribution items via email, text, or via the recipient user interface 115. When the system identifies a physical item has having supplemental content associated therewith, when the items are scanned and/or processed, the system will send the supplemental content to the recipients according to the requirements or requests in the item information, or according to distribution network policies or practices. Where the supplemental content is a copy of the distribution item, the distribution network will not send a second copy of the item. In some embodiments, the supplemental content is sent to the recipient of the physical distribution item in the morning of the day the physical distribution item is to be delivered, upon confirmation of delivery of the physical distribution item, or at another time relative to the delivery of the physical distribution item.

The process 470 moves to step 480, wherein the system identifies potential recipients (which can be described herein as “second recipients”) for receiving the supplemental content. The processor can use the item information, including geography, preference categories, etc., to identify second recipients for the supplemental content. The processor can cross-reference or match the item information for the physical distribution item with the preferences or other characteristics of the second recipients stored in the CPDB 110.

The system can identify a potential second recipient by identifying users who live in the geographic area indicated in the item information, who have one or more same preferences as indicated in the item information, who have opted in to receiving informed offers, who have been categorized in one or more categories as the item information, and/or any combination of these, or other factors that would be apparent to one of skill in the art guided by this disclosure.

The process 470 next moves to step 482, wherein the system delivers the supplemental content to the identified recipients via email, text, via the recipient user interface 115. Delivering the supplemental content can be making the supplemental content available for viewing in the second recipient's dashboard. Where the supplemental content includes sending a free sample or sending a coy of the physical distribution item, delivering the supplemental content can include automatically initiating item processing equipment to obtain, route, and provide for delivery, the sample or the copy of the distribution item. The item processing equipment can receive a signal from the system that includes the address of the second recipient, can automatically obtain from a storage area the copy of the item; spray, print, or attach the address of the second recipient to the item; and induct the item into sorting equipment, sort the item, and provide to a delivery resource for delivery. In some embodiments, initiation of the automatic sending of the sample item or copy of the distribution item in step 482 can occur when the system identifies the distribution item is out for delivery to the first recipient, has been delivered to the first recipient, or at another time related to the delivery of the distribution item to the first recipient. In some embodiments, the sample item or the copy of the distribution item may not be sent step 482, but may be sent later, using the same process described here, after the second recipient interacts with the digital supplemental content, as will be described.

The process 470 moves to decision state 484, wherein the system determines whether the second recipient interacts with the supplemental content. This can occur as described elsewhere herein, including whether the second recipient accesses the particular supplemental content associated with the physical distribution item that was sent to the first recipient. Accessing the supplemental content can also include requesting a free sample, requesting a copy of the same distribution item that was sent to the first recipient, etc.

If the second recipient does not interact with the supplemental content, the process 472 moves to step 486, wherein the system communicates with the item sender that there was no interaction with the supplemental content. In some embodiments, the supplemental content can be available for interaction for a limited amount of time, such as a number of days. The time period can be included in the item information provided by the item sender. If the second recipient has not interacted with the supplemental content in amount of time prescribed, the system can remove the supplemental content from the dashboard, or can make the supplemental content no longer interactive or no longer displayed to the second recipient.

The process 472 moves to step 492 and ends.

If, in decision state 484, it is determined that the recipient interacted with the supplemental content, such as with the digital supplemental content in a dashboard, in an email, etc., the system can initiate sending additional supplemental content to the second recipient. For example, the item information for the physical distribution item may include an additional portion that is sent or made available when the second recipient interacts with the supplemental content. The additional portion can be a free sample, a copy of the distribution item, as described above, an additional coupon, discount, etc. In some embodiments, the fact of an interaction can trigger the sending of the additional portion of the supplemental content. In some embodiments, the second recipient may be given, in the supplemental content, options for additional content, and which the second recipient may specifically select to initiate specific actions or items being sent..

The process 470 moves to step 490, wherein the system communicates with the item sender that there was an interaction, what the nature of the interaction was, and what, if any, additional content was requested and/or sent.

The process 470 moves to step 492 and ends.

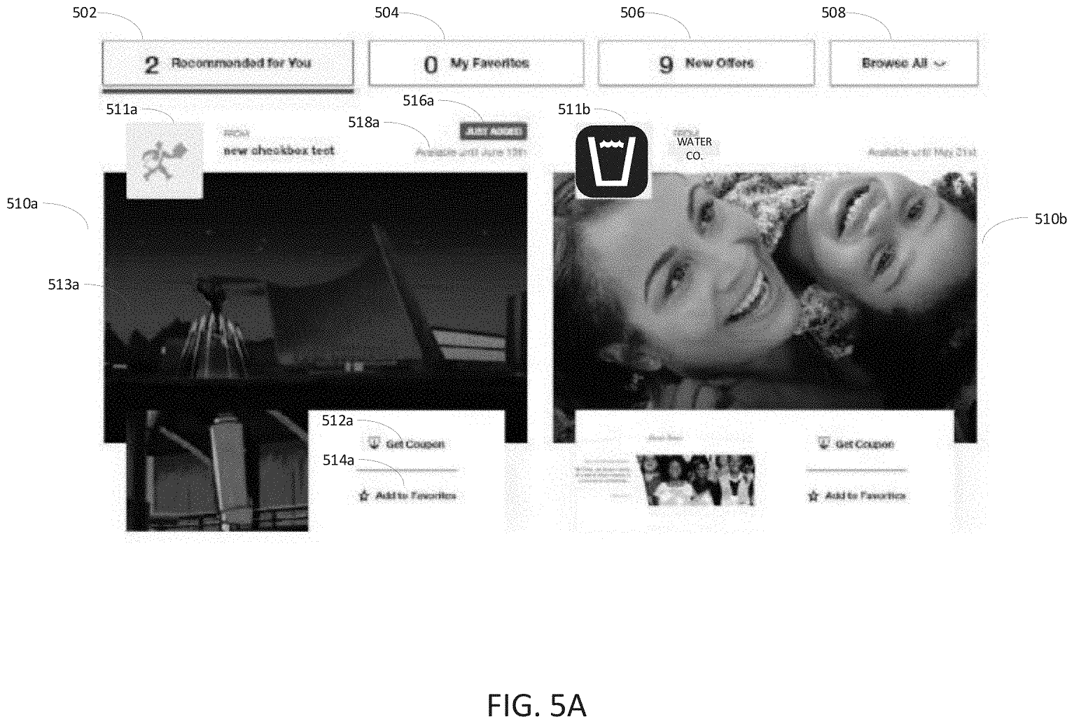

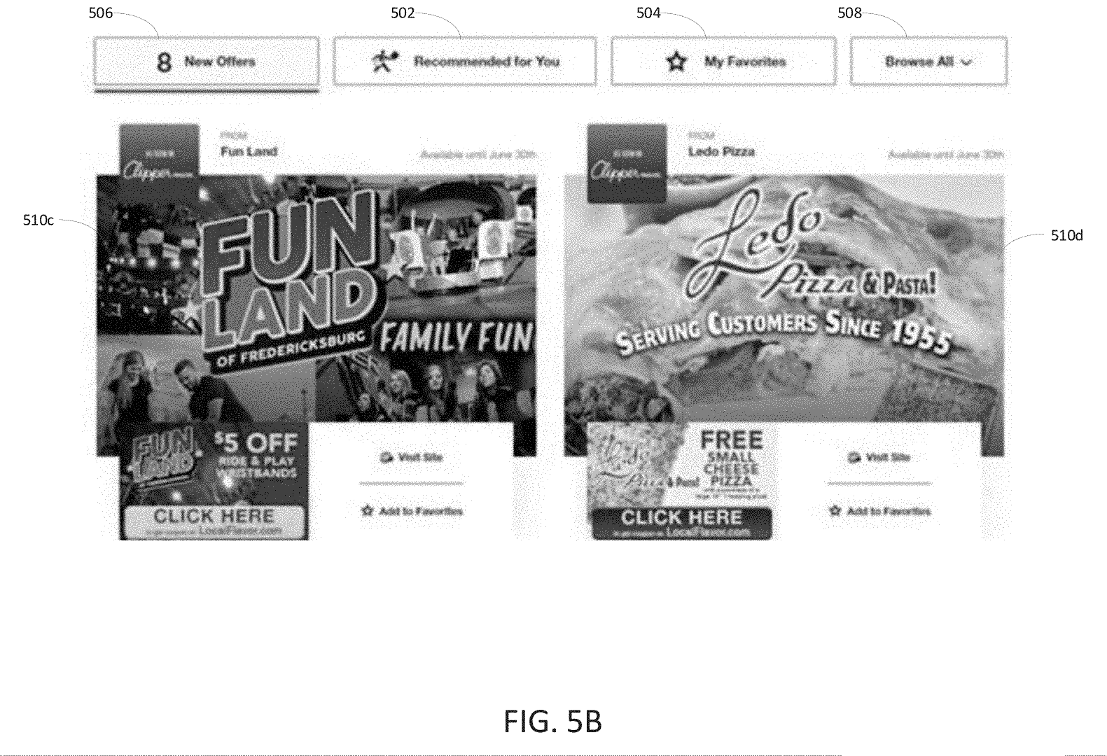

FIGS. 5A-5B show example screenshots of an interface 500 (for example, accessible via the content interface 125) that a user will use to view or interact with available offers. FIG. 5A shows an example interface 500 that the user can use to identify recommended offers. The interface 500 shows that the user is viewing the recommended offers, as shown by the selection of the “Recommended for You” tab 502. Selection of the tab 502 may display to the user via the interface 500 a number of recommended offers for the user. The recommended offers may be identified based on the user's profile, history of reviewed and/or selected offers, and the like. In some embodiments, the system 100 utilizes a machine learning or similar subsystem (for example, part of the analytics tools engine 112) to parse the user's profile, history, and so forth, and generate recommended offers. For example, the machine learning system may weight different information in the user's profile, history, and so forth, to generate the recommended offers, where the most recently updated information of the history and the profile is weighted higher. For example, the machine learning system may review all available offers and filter those available offers based on user selections in the user's profile and the historical recommended offers selected by the user. Thus, the recommended offers may be identified based on selections in the user's profile that the user may be aware and/or conscious of and on historical browsing and/or offer information that the user is less or not aware of.

As shown, the interface 500 shows two offers 510a and 510b. Each offer may include multiple components: an icon 511a-b, a link 512, an add to favorites button 514, a relevance or newness indicator 516, and an expiration date 518. The icon 511 may represent the company associated with the offer. For example, if the offer is for a product or service, the icon 511 may be the logo or an image commonly associated with the company that offers the product or service. For example, the offer 510a may be an offer for a service provided by the delivery service and, thus, the icon 511a for the offer 510a may be a courier or similar item carrier icon. The offer 510a includes a large image or display portion 513a that may include an advertisement or similar display portion 513a includes a visual or display component associated with the offer 510a. In some embodiments, the visual component in the display portion 513a includes a video or an interactive component (for example, a short game, user input fields, and so forth). In some embodiment, the display portion 513a includes an icon for an audio component. In some instances, if the user selects the display portion 513a, the interface 500 directs the user to more information regarding the offer 510a, for example the terms and conditions for the offer 510a and so forth.

The link 512a of the offer 510a may be a link to a coupon, a website, or another online destination that enables the user to access the offer. For example, when the offer is a printable coupon, the link 512a may cause or enable the user to download the printable coupon. Similarly, the link 512a may take the user to a website where the user can apply for the displayed offer or purchased the displayed product or service. The add to favorites button 514 may enable the user to add the displayed offer to a list of saved offers, for example a favorites list. In some instances, offers for which the user selects the add to favorite button will show up on the my favorites screen when the user selects the “My Favorites” tab 504.

The relevance or newness indicator 516 may represent to the user whether the displayed offer 510 is new. The offer 510 may be new if the user is viewing the offer for the first time or if the offer was recently added to the available offers. In some instances, the user may manually change a status of the indicator 516 for the displayed offer to mark it as new or previously viewed. Alternatively, the indicator 516 indicates how relevant the offer 510 is for the user. For example, the indicator 516a shows that the offer 510a for the delivery service is a newly added offer. The expiration date 518 may indicate when the offer 510 expires. The expiration date 518 may be a calendar date, a countdown of days until the offer expires, and the like. The expiration date 518a for the offer 510a indicates that the offer 510a is available for the user until June 10^{th}.

Thehe interface 500 shows details for individual offers that are associated with a selected tab, here the Recommended for You tab 502. In some instances, the information for each offer 510 is common for any of the other tabs of the interface 500. In some instances, the My Favorites tab 504 may include a button to remove an offer from the favorites list (not shown). Furthermore, though not shown, the interface 500 may enable the user to share one or more offers with one or more other users or to have the analysis of recommendations remove aspects that led to a particular offer being shown.

FIG. 5B shows the example interface 500 that the user can use to identify new offers. The interface 500 shows that the user is viewing the recommended offers, as shown by the selection of the “New Offers” tab 506. Selection of the tab 506 may display to the user via the interface 500 a number of new offers for the user. The new offers may be identified based on which offers have been added to the system 100 (for example, by the corresponding companies, etc.) since the user last reviewed the offers on the New Offers tab 506 or that were added within a threshold period of time prior to when the user accesses the interface 500. In some instances, offers shown on the

New Offers tab 506 may comprise all offers that would otherwise include the newness indicator 516. Thus, the offers shown on the New Offers tab 506 may not include the newness indicator 516 since all shown offers would be new. In some instances, though not shown, the user may scroll through the interface 500 to view additional offers to the offers 510c and 510d shown in FIG. 5B.

In some instances, each of the tabs of the interface 500 shows a number of offers associated with that tab. For example, in FIG. 5B, the interface shows that there are 8 new offers by the “8” in the New Offers tab 506, where there is no number in the Recommended for You tab 502, the user can understand that there are no recommended offers, or no new recommended offers; and no offers in the My Favorites tab 504. The interface 500 also includes “Browse All” tab 508 that enables the user to view all offers that are available without any filtering applied (at least initially).

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the development should not be taken to imply that the terminology is being re-defined herein to be restricted to including any specific characteristics of the features or aspects of the technology with which that terminology is associated.

The technology is operational with numerous other general purpose or special purpose computing system environments or configurations. Examples of well-known computing systems, environments, and/or configurations that may be suitable for use with the development include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX® or Microsoft Windows®.

The system control may be written in any conventional programming language such as and ran under a conventional operating system. For example, any industry standard programming languages for which many commercial compilers can be used to create executable code may be used. The system control may also be written using interpreted languages.

Those of skill will further recognize that the various illustrative logical blocks, modules, circuits, and algorithm steps described in connection with the embodiments disclosed herein may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the present development.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the development should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present development. At the very least, and not as an attempt to limit the application of the doctrine of equivalents to the scope of the claims, each numerical parameter should be construed in light of the number of significant digits and ordinary rounding approaches.

The above description discloses several methods and materials of the present development. This development is susceptible to modifications in the methods and materials, as well as alterations in the fabrication methods and equipment. Such modifications will become apparent to those skilled in the art from a consideration of this disclosure or practice of the development disclosed herein. Consequently, it is not intended that this development be limited to the specific embodiments disclosed herein, but that it cover all modifications and alternatives coming within the true scope and spirit of the development as embodied in the attached claims.

What is claimed is:

1. A system for handling distribution items, comprising:
item processing equipment comprising an imaging device, the imaging device configured to generate an image of a physical distribution item and interpret an identifier on the physical distribution item, and to generate scan information which includes the identifier;
an item image server configured to store the image of the physical distribution item and to associate the identifier with the stored image;
a user interface configured to make available for viewing by a user an offer associated with the physical distribution item; and
a central hub in communication with the item image server and the user interface, the central hub configured to:
identify the offer associated with the physical distribution item;
provide to the user a prompt whether to view the offer;
receive a response to the prompt from the user;
when the user views the offer:
provide, to the user, the offer for viewing via the user interface; and
update in a user database a user record associated with the user to indicate that the user opts to view the offer.

2. The system of claim 1, wherein the item identifier includes an address, a name, a brand, a symbol, or a trademark.

3. The system of claim 1, wherein the central hub is further configured to identify the offer associated with the physical distribution item by comparing the item identifier to a business database storing available offers in a vicinity of a recipient of the physical distribution item.

4. The system of claim 1, wherein the user interface is further configured to receive from the user preferences and wherein the central hub is further configured to provide the prompt to the user only if the offer is associated with the received preferences.

5. The system of claim 1, wherein the central hub is further configured to determine when the offer is available to be shared with the user.

6. The system of claim 1, wherein the offer associated with the physical distribution item comprises a digital coupon, an option for a physical sample, or an option for an in-person appointment with the corresponding business.

7. The system of claim 1, wherein the user record may be a user profile that the user has established by providing to the user interface personal information such as age, gender, item preferences, or recent purchases.

8. The system of claim 1, wherein when the user views the offer, and the user record associated with the user is updated to indicate that the user opts to view the offer, the central hub updates the user record to include the preferences associated with the offer or the physical distribution item.

9. The system of claim 1, wherein the user and the recipient of the physical distribution item are different entities.

10. The system of claim 1, wherein the user can communicate with the central hub to send the offer to a second user and have the central hub send the offer to a specific second user of the first user's choice.

11. A method for handling distribution items, the method comprising:
processing by item processing equipment an item by generating an image of a physical distribution item, interpreting an identifier on the physical distribution item, and generating scan information which includes the identifier;
storing in a memory in communication with the image of the physical distribution item and associating the identifier with the stored image;
making available via a server for viewing by the user an offer associated with the physical distribution item;
identifying the offer associated with the physical distribution item available to be shared with the user;
providing the user in the user interface a prompt whether to view the offer;
receiving in the user interface a response to the first prompt form the user;
when the user opts to view the offer:
providing, to the user, the offer for viewing; and
updating a user record associated with the user in a user database to indicate that the user viewed the offer.

12. The method of claim 11, wherein interpreting an identifier further comprises identifying item information such as an address, a name, a brand, a symbol, or trademark.

13. The method of claim 11, wherein identifying the offer associated with the physical distribution item availed to be shared with the user further comprises identifying the offer associated with the physical distribution item and comparing the item identifier to a business database storing available offers in a vicinity of a recipient of the physical distribution item.

14. The method of claim 11, wherein providing the user in the user interface a first prompt further comprises providing the prompt to the user only if the offer is associated with the received preferences.

15. The method of claim 11, wherein making available an offer associated with the physical distribution item comprises making an offer available such as a digital coupon, an option for a physical sample, or an option for an in-person appointment with the corresponding business.

16. The method of claim 11, wherein updating a user record further includes updating the user interface personal information such as age, gender, item preferences, or recent purchases.

17. The method of claim 11, wherein updating a user record associated with the user in a user database to indicate that the user viewed the offer further comprises including in the user record the preferences associated with the offer or the physical distribution item.

18. The method of claim 11, wherein the user and the recipient of the physical distribution item are different entities.

19. The method of claim 11, wherein providing, to the user, the offer for viewing further comprises the user providing whether the user wants to send the offer to a second user of their choice.

20. A system for handling distribution items, comprising:
item processing equipment comprising an imaging device, the imaging device configured to identify a physical distribution item, to interpret an identifier on the physical distribution item, and to generate scan information which includes the identifier;
an item offer server configured to store an offer associated with the physical distribution item;
a user interface configured to present the stored offer to a user of the physical distribution item and receive user inputs relating to the stored offer; and
a central hub in communication with the item image server and the user interface, the central hub configured to:
identify an offer, associated with the physical distribution item, available to be shared with other users;
provide to the user a first prompt whether to share the offer with one or more other users;
receive a response to the first prompt from the user;
when the user opts to share the offer, provide, to the user, a second prompt whether to share user information along with the shared offer;
receive a response to the second prompt from the user;
when the user opts not to share user information along with the shared offer, provide the shared offer to the one or more other users without the user information;
update a database to indicate that the user shared the offer without sharing the recipient information; and
distribute the shared offer to the one or more other users for viewing by the one or more other users.
